(19) United States
(12) Patent Application Publication
(10) Pub. No.: US 2026/0210868 A1
(43) Pub. Date: Jul. 23, 2026

(54) Simultaneous, Multiple Channel Measurements Of Semiconductor Structures At Different Nominal Azimuth Angles

(71) Applicant: KLA Corporation, Milpitas, CA (US)

(72) Inventors: Avi Abramov, San Jose, CA (US); Alexander Kuznetsov, Austin, TX (US)

(21) Appl. No.: 19/035,633

(22) Filed: Jan. 23, 2025

(51) Int. Cl. G01N 21/88; G01N 21/21; G01N 21/55; G01N 21/95

(52) U.S. Cl. CPC G01N 21/8806; G01N 21/211; G01N 21/55; G01N 21/9501; G01N 2021/213; G01N 2021/8845; G01N 2021/8848; G01N 2201/06113

(57) ABSTRACT

Methods and systems for simultaneously performing optical based measurements of a semiconductor structure with multiple measurement channels each at different nominal azimuth angles are presented herein. In a further aspect, the measurement channels simultaneously collect measurement data resolved in wavelength, collection angle, polarization, or any combination thereof, at each nominal azimuth angle. In some embodiments, optical radiation generated by a shared illumination source is subdivided into multiple segments, each routed to a different measurement channel. In this manner, more of the optical output of the illumination source is simultaneously directed to the measurement spot of the semiconductor wafer. In some embodiments, multiple illumination pupil apertures are arranged to select different numerical apertures in the azimuth direction, the angle of incidence direction, or both, corresponding to each measurement channel. In another aspect, different measurement channels of a multi-angle measurement system perform measurements over a different spectral range.

### TECHNICAL FIELD

The described embodiments relate to metrology systems and methods, and more particularly to methods and systems for improved measurement of semiconductor structures.

### BACKGROUND INFORMATION

Semiconductor devices such as logic and memory devices are typically fabricated by a sequence of processing steps applied to a specimen. The various features and multiple structural levels of the semiconductor devices are formed by these processing steps. For example, lithography among others is one semiconductor fabrication process that involves generating a pattern on a semiconductor wafer. Additional examples of semiconductor fabrication processes include, but are not limited to, chemical-mechanical polishing, etch, deposition, and ion implantation. Multiple semiconductor devices may be fabricated on a single semiconductor wafer and then separated into individual semiconductor devices.

Metrology processes are used at various steps during a semiconductor manufacturing process to measure defects on wafers to promote higher yield. Optical metrology techniques offer the potential for high throughput without the risk of sample destruction. A number of optical metrology based techniques including scatterometry, ellipsometry, and reflectometry implementations and associated analysis algorithms are commonly used to characterize critical dimensions, film thicknesses, composition, overlay and other parameters of nanoscale structures.

As devices (e.g., logic and memory devices) move toward smaller nanometer-scale dimensions, characterization becomes more difficult. Devices incorporating complex three-dimensional geometry and materials with diverse physical properties contribute to characterization difficulty. For example, modern memory structures are often high-aspect ratio, three-dimensional structures fabricated from opaque materials that make it difficult for optical radiation to penetrate to the bottom layers.

To overcome penetration depth issues, traditional imaging techniques such as TEM, SEM etc., are employed with destructive sample preparation techniques such as focused ion beam (FIB) machining, ion milling, blanket or selective etching, etc. For example, transmission electron microscopes (TEM) achieve high resolution levels and are able to probe arbitrary depths, but TEM requires destructive sectioning of the specimen. Several iterations of material removal and measurement generally provide the information required to measure the critical metrology parameters throughout a three dimensional structure. But, these techniques require sample destruction and lengthy process times. The complexity and time to complete these types of measurements introduces large inaccuracies due to drift of etching and metrology steps. In addition, these techniques require numerous iterations which introduce registration errors.

Optical based metrology systems offer the potential for high-throughput, non-destructive measurement of many advanced targets (e.g., complex 3D structures, structures smaller than 10 nm, structures employing opaque materials) and measurement applications (e.g., line edge roughness and line width roughness measurements).

Traditional optical based measurement techniques employ indirect methods of measuring physical properties of a specimen under measurement. In some examples, a physics-based measurement model is created that attempts to predict raw measurement signals based on assumed values of one or more model parameters. The measurement model must properly model both the device under measurement and the measurement system to adequately model the physical interaction between the two, i.e., the light scattered from the device under measurement. The measurement model includes parameters associated with the metrology tool itself, e.g., system parameters and parameters associated with the specimen under measurement. When solving for parameters of interest, some specimen parameters are treated as fixed valued and other specimen parameters of interest are floated, i.e., resolved based on the raw measurement signals. The indirect approach to estimating values of parameters of interest is challenging to implement due to the complexity of the measurement model required to adequately represent light scattered from a complex semiconductor structure.

Lack of measurement sensitivity and parameter correlation limit measurement performance of optical metrology systems. In addition, the increasing number of parameters required to characterize complex structures, leads to increasing parameter correlation. As a result, the parameters characterizing the target often cannot be reliably decoupled with available measurement signal information.

Existing optical based metrology systems are limited to specific hardware configurations. The specific hardware configurations are typically optimized to perform well with specific types of targets, but are not broadly applicable to the different types of targets associated with modern, complex semiconductor structures. For example, existing optical CD metrology systems are often configured with a small illumination NA at a single nominal azimuth angle and a limited set of angles of incidence to penetrate deep structures. The small illumination NA limits measurement signal to noise ratio due to limited illumination source radiance within the selected illumination NA and optical losses associated with axial transmission within the optical system.

In another example, existing optical CD metrology systems are often configured to perform broadband measurements in a specific optical configuration that imposes very challenging specifications for optical components, detectors, and light sources to achieve high optical efficiency and low signal to noise ratio over a broad spectrum of light. Increasingly, the requirements on optical components are becoming prohibitively expensive, or impossible, to attain.

In addition, typically, measurements are resolved in wavelength and polarization at one nominal angle of incidence. In these configurations, the amount of signal information collected from a measurement target may be insufficient to de-correlate model parameters and successfully measure complex multi-layer and multi structural targets like Gate-All-Around (GAA) and Complementary Field Effect Transistor (CFET) devices. Moreover, sequential measurements performed at different nominal angles of incidence may reduce throughput to unacceptable levels.

Future metrology applications present challenges for metrology due to increasingly small resolution requirements, multi-parameter correlation, increasingly complex geometric structures including high aspect ratio structures, and increasing use of opaque materials. Thus, methods and systems for improved optical and x-ray based measurements are desired.

To further improve device performance, the semiconductor industry continues to focus on vertical integration, rather than lateral scaling. Thus, accurate measurement of complex, fully three dimensional structures is crucial to ensure viability and continued scaling improvements. However, ongoing reductions in feature size, increasing depths and layers of structural features, and increasing use of opaque material layers impose difficult requirements on optical metrology systems. Optical metrology systems must meet high precision and accuracy requirements for increasingly complex targets at high throughput to remain cost effective. In this context, inadequate signal information has emerged as a performance limiting issue in the design of optical metrology systems suitable for complex, fully three dimensional structures with a relatively large number of layers. Thus, improved metrology systems and methods to overcome these limitations are desired.

### SUMMARY

Methods and systems for simultaneously performing optical based measurements of a semiconductor structure with multiple measurement channels each at different nominal azimuth angles are presented herein. Simultaneous, multiple channel measurements of semiconductor structures at multiple, nominal azimuth angles increases measurement signal information while maintaining high measurement throughput. In a further aspect, the measurement channels simultaneously collect measurement data resolved in wavelength, collection angle, polarization, or any combination thereof, at each nominal azimuth angle. In some examples, the availability of measurement data sets resolved in wavelength, polarization, and collection angle generated by multiple measurement channels at different nominal azimuth angles, streamlines the measurement recipe optimization process for complex, three-dimensional semiconductor structures.

In some embodiments, optical radiation generated by an illumination source is efficiently employed by subdividing the beam into multiple segments, each routed to a different measurement channel. In this manner, more of the optical output of the illumination source is simultaneously directed to the measurement spot of the semiconductor wafer. This results in less loss of illumination light, and thus, increased measurement throughput.

In some embodiments, one or more measurement channels of a multi-angle measurement system are illuminated by illumination light generated by a narrowband illumination source, e.g., a laser based illumination source. In some embodiments, one or more measurement channels of a multi-angle measurement system are illuminated by illumination light generated by a broadband illumination source.

In some embodiments, the apertures of an illumination pupil aperture are arranged in any suitable configuration to select different numerical apertures in the azimuth direction, the angle of incidence direction, or both. In this manner, illumination light directed to different measurement channels has a numerical aperture in the azimuth and angle of incidence directions that is tuned to the measurement application associated with each measurement channel. In some embodiments, the illumination numerical aperture associated with one or more measurement channels is greater than 15 degrees in the AOI direction.

In general, a multi-angle measurement system includes two or more measurement channels, simultaneously collecting measurement data, each at different nominal azimuth angles. Moreover, each measurement channel may be configured similarly or differently than any other measurement channel. In some embodiments, at least one measurement channel of a multi-angle measurement system is illuminated by illumination light generated by a different illumination source than other measurement channels.

In another aspect, at least one measurement channel of a multi-angle measurement system performs measurements over a different spectral range than another measurement channel of the multi-angle measurement system.

In a further aspect, the measurement signals generated by at least one measurement channel of a multi-angle measurement system are simultaneously resolved in wavelength, collection angle, and polarization. In some other embodiments, polarization is also resolved sequentially.

In a further aspect, a computing system is configured to estimate values of one or more parameters of interest characterizing structural characteristics of a specimen under measurement based on measurement signals generated by at least two different measurement channels, each simultaneously detecting light collected from a common measurement spot in response to illumination light provided to the measurement spot at different nominal azimuth angles.

The foregoing is a summary and thus contains, by necessity, simplifications, generalizations and omissions of detail; consequently, those skilled in the art will appreciate that the summary is illustrative only and is not limiting in any way. Other aspects, inventive features, and advantages of the devices and/or processes described herein will become apparent in the non-limiting detailed description set forth herein.

### BRIEF DESCRIPTION OF THE DRAWINGS

FIG. 1 is a diagram illustrative of an embodiment of a system for performing multi-angle measurements of semiconductor structures as described herein.

FIG. 2 is a simplified diagram illustrative of an illumination pupil aperture of a multi-angle measurement system in one embodiment.

FIG. 3 is a diagram illustrative of a measurement channel of a multi-angle measurement system in one embodiment.

FIG. 4 is a diagram illustrative of another embodiment of a system for performing multi-angle measurements of semiconductor structures as described herein.

FIG. 5 is a simplified diagram illustrative of a spectrally resolved polarimeter that simultaneously detects measurement signals in wavelength, angle of incidence, and polarization.

FIG. 6 is a simplified exploded view of a polarization pixelated camera in one embodiment.

FIG. 7 is a simplified diagram illustrative of a spectrally resolved polarimeter that simultaneously detects measurement signals in wavelength, angle of incidence, and polarization in another embodiment.

FIG. 8 is a simplified diagram illustrative of a spectrally resolved polarimeter that both simultaneously and sequentially detects measurement signals in wavelength, angle of incidence, and polarization in one embodiment.

FIG. 9 is a simplified diagram illustrative of a spectrally resolved polarimeter that both simultaneously and sequentially detects measurement signals in wavelength, angle of incidence, and polarization in another embodiment.

FIG. 10 is a diagram illustrative of a trained multi-angle measurement engine 250 in one embodiment.

FIG. 11 is a diagram illustrative of a multi-angle measurement model training engine 260 in one embodiment.

FIG. 12 is a diagram illustrative of a vertically integrated memory structure in one embodiment.

FIG. 13 depicts an embodiment 280 of a combined illumination source.

FIG. 14A depicts another embodiment 300 of a combined illumination source.

FIG. 14B depicts another embodiment 320 of a combined illumination source.

FIG. 14C depicts another embodiment 340 of a combined illumination source.

FIG. 15 depicts a plot illustrative of the specific detectivity of various detector technologies operating at specified temperatures.

FIG. 16 depicts an illustration of a multi-zone infrared detector 370.

FIG. 17 illustrates typical photosensitivity curves of four available Indium Gallium Arsenide (InGaAs) sensors.

FIG. 18 illustrates method 400 of performing mutli-angle measurements as described herein.

### DETAILED DESCRIPTION

Reference will now be made in detail to background examples and some embodiments of the invention, examples of which are illustrated in the accompanying drawings.

Methods and systems for simultaneously performing optical based measurements of a semiconductor structure with multiple measurement channels each at different nominal azimuth angles are presented herein. In a further aspect, the measurement channels simultaneously collect measurement data resolved in wavelength, collection angle, polarization, or any combination thereof, at each nominal azimuth angle.

Simultaneous, multiple channel measurements of semiconductor structures at multiple, nominal azimuth angles increases measurement signal information while maintaining high measurement throughput. In some embodiments, at least one of the measurement channels simultaneously resolves detected measurement signals as a function of wavelength, collection angle, and polarization. The increase in available measurement signal information increases measurement sensitivity and reduces parameter correlation associated with measurements of complex, three-dimensional semiconductor structures, e.g., gate-all-around (GAA) and complimentary field-effect transistor (CFET) devices.

In some examples, the availability of measurement data sets resolved in wavelength, polarization, and collection angle generated by multiple measurement channels at different nominal azimuth angles, streamlines the measurement recipe optimization process for complex, three-dimensional semiconductor structures.

In general, the hardware configurations described herein increase the available measurement data without loss of measurement throughput. In some embodiments, optical radiation generated by an illumination source is more efficiently employed by subdividing the beam into multiple segments, each routed to a different measurement channel. In this manner, more of the optical output of the illumination source is simultaneously directed to the measurement spot of the semiconductor wafer. This results in less loss of illumination light, and thus, increased measurement throughput.

In one aspect, a multi-angle measurement system includes at least two different measurement channels, each simultaneously detecting light collected from a common measurement spot in response to illumination light provided to the measurement spot at different nominal azimuth angles at the wafer.

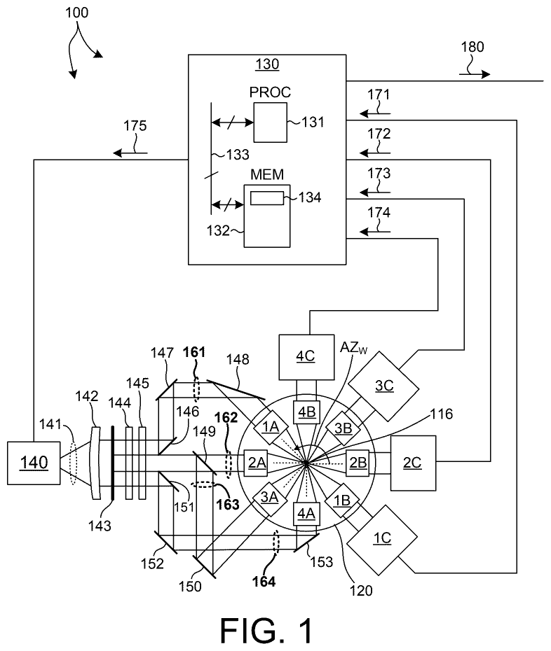

FIG. 1 is a simplified diagram illustrative of a multi-angle measurement system 100 in at least one embodiment. As depicted in FIG. 1, multi-angle measurement system 100 includes four different measurement channels. Measurement channel 1 includes illumination optics 1A, collection optics 1B, and detector 1C. Measurement channel 2 includes illumination optics 2A, collection optics 2B, and detector 2C. Measurement channel 3 includes illumination optics 3A, collection optics 3B, and detector 3C. Measurement channel 4 includes illumination optics 4A, collection optics 4B, and detector 4C. Although, each measurement channel depicted in FIG. 1 employs illumination and collection optics, in general, any measurement channel of a multi-angle measurement system includes a detector, and optionally, illumination optics, collection optics, or both.

As depicted in FIG. 1, illumination beams 161-164 are each directed to measurement spot 116 at different nominal azimuth angles at wafer 120, e.g., nominal azimuth angles of 135 degrees, 180 degrees, 225 degrees, and 270 degrees, respectively. In the embodiment depicted in FIG. 1, each nominal azimuth angle is separated from the others by forty five degrees. In some embodiments, each nominal azimuth angle is separated from the others by at least ten degrees. However, in general, any number of different illumination beams may be directed to a measurement spot on a wafer at different nominal azimuth angles.

In a further aspect, at least two measurement channels are illuminated by illumination light generated by a common illumination source. As depicted in FIG. 1, multi-angle measurement system 100 includes four measurement channels, each illuminated by illumination light generated by a common illumination source, e.g., illumination source 140. In some embodiments, all measurement channels of a multi-angle measurement system, e.g., measurement channels 1-4 depicted in FIG. 1, are illuminated by illumination light generated by a common illumination source.

In some embodiments, one or more measurement channels of a multi-angle measurement system are illuminated by illumination light generated by a narrowband illumination source, e.g., a laser based illumination source. In some of these embodiments, the narrowband illumination source is a single wavelength illumination source.

In some embodiments, one or more measurement channels of a multi-angle measurement system are illuminated by illumination light generated by a broadband illumination source. As depicted in FIG. 1, multi-angle measurement system 100 includes a broadband illumination source 140 that generates an amount of illumination light 141 including a range of wavelengths.

In some embodiments, illumination source 140 includes one or more illumination sources that emit illumination light including wavelengths in a range from 170 nanometers to 2,500 nanometers. In some embodiments, illumination source 140 is a single illumination source, e.g., laser sustained plasma (LSP) light source (a.k.a., laser driven plasma source) or arc lamp source, that emits illumination light in the ultraviolet, visible, and infrared spectra, including ultraviolet wavelengths down to 170 nanometers and infrared wavelengths greater than two micrometers, e.g., illumination wavelengths ranging from 170 nanometers to 2,500 nanometers.

In some other embodiments, illumination source 140 is a combined illumination source that emits illumination light in the ultraviolet, visible, and infrared spectra, including ultraviolet wavelengths down to 170 nanometers and infrared wavelengths greater than two micrometers, e.g., illumination wavelengths ranging from 170 nanometers to 2,500 nanometers. In some other embodiments, illumination source 140 is a combined illumination source that emits illumination light including wavelengths in a range from 170 nanometers to 7,000 nanometers.

In some embodiments, illumination source 140 includes a supercontinuum laser source and a laser sustained plasma light source. The supercontinuum laser source provides illumination at wavelengths greater than 400 nanometers, and in some embodiments, up to 5 micrometers, or more. The laser sustained plasma (LSP) light source (a.k.a., laser driven plasma source) produces photons across the entire wavelength range from 170 nanometers to 2500 nanometers, and beyond. The pump laser of the LSP light source may be continuous wave or pulsed. In some embodiments, combined illumination source 140 includes a supercontinuum laser source and an arc lamp, such as a Xenon arc lamp. However, a laser-driven plasma source produces significantly more photons than a Xenon lamp across the entire wavelength range from 170 nanometers to 2500 nanometers, and is therefore preferred.

In general, a combined illumination source 140 includes a combination of a plurality of broadband or discrete wavelength light sources. The light generated by combined illumination source 140 includes a continuous spectrum or parts of a continuous spectrum, from ultraviolet to infrared (e.g., vacuum ultraviolet to long infrared). In general, combined illumination light source 140 may include a supercontinuum laser source, an infrared helium-neon laser source, a silicon carbide globar light source, a tungsten halogen light source, one or more infrared LEDs, one or more infrared lasers or any other suitable infrared light source generating wavelengths greater than two micrometers, and an arc lamp (e.g., a Xenon arc lamp), a deuterium lamp, a LSP light source, or any other suitable light source generating wavelengths in a range from 170 nanometers to 2,000 nanometers, 170 nanometers to 2,500 nanometers, or greater.

In general, combined illumination source 140 includes multiple illumination sources optically coupled in any suitable manner. In some embodiments, light emitted by a supercontinuum laser source is directly coupled through the plasma generated by the ultraviolet/visible light source.

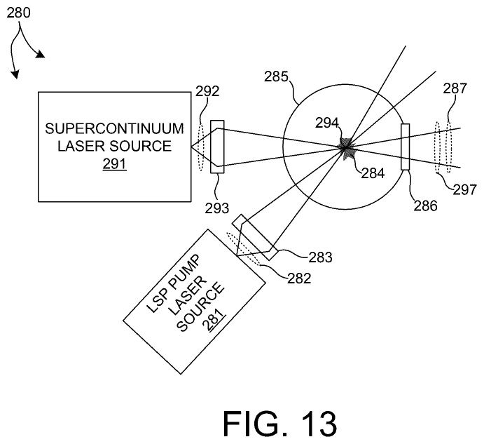

FIG. 13 depicts an embodiment 280 of a combined illumination source 140. As depicted in FIG. 13, a LSP pump laser source 281 generates pump light 282 that is focused by focusing optics 283 to sustain a plasma 284 contained by bulb 285. Plasma 284 generates broadband spectrum light over a wavelength range of ultra-violet to short infrared. Bulb 285 includes an exit port 286. LSP output light 287 is the portion of light from plasma 284 that passes through exit port 286 and is directed towards the illumination optics as described with reference to FIG. 1. In addition, supercontinuum laser source 291 generates infrared light 292 that is focused by focusing optics 293 to a focus 294 at or near plasma 284. Supercontinuum output light 297 is the portion of light from the focus 294 that passes through exit port 286 and is directed towards the illumination subsystem as described with reference to FIG. 1. In one example, the LSP output light 287 and supercontinuum output light 297 are co-located. In this manner, infrared light 297 from supercontinuum source 291 is effectively combined with ultraviolet/visible light 287 from LSP laser source 281. In one example, LSP output light 287 and supercontinuum output light 297 have the same or similar illumination numerical aperture. In another example, LSP output light 287 and supercontinuum output light 297 have different illumination numerical aperture. In some examples, bulb 285 is constructed from Calcium Fluoride or Magnesium Fluoride to transmit wavelengths above 2.5 micrometers generated by supercontinuum laser source 291. In some other examples, bulb 285 includes one or more exit ports 286 fabricated from Calcium Fluoride or Magnesium Fluoride to transmit wavelengths above 2.5 micrometers generated by supercontinuum laser source 291. A conventional bulb constructed from fused silica does not transmit significant light above 2.5 micrometers, and is thus unsuitable for combining light generated by the supercontinuum laser source 291 in the manner described herein. In some embodiments, the LSP pump laser source 281 is a continuous wave laser. In some other embodiments, the LSP pump laser source 281 is a pulsed laser.

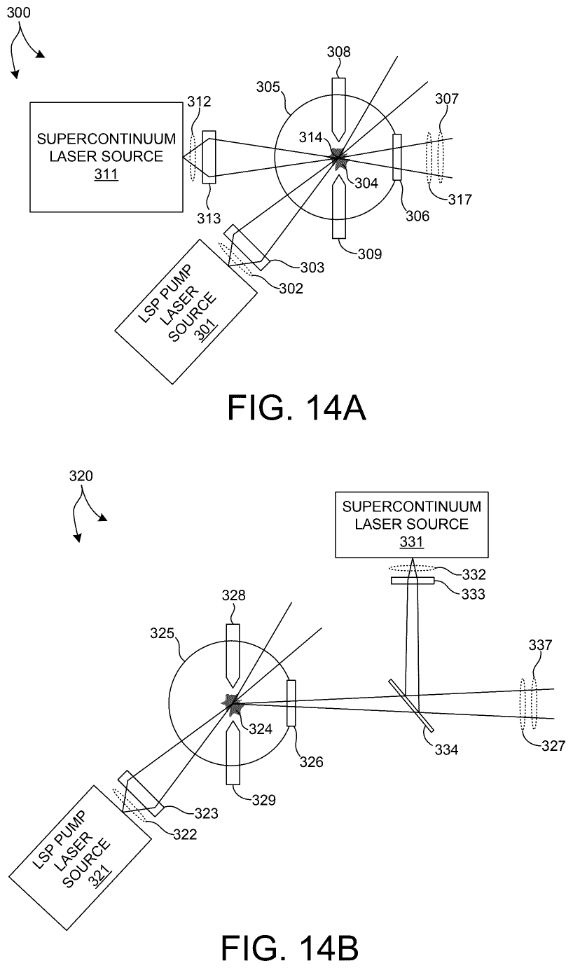

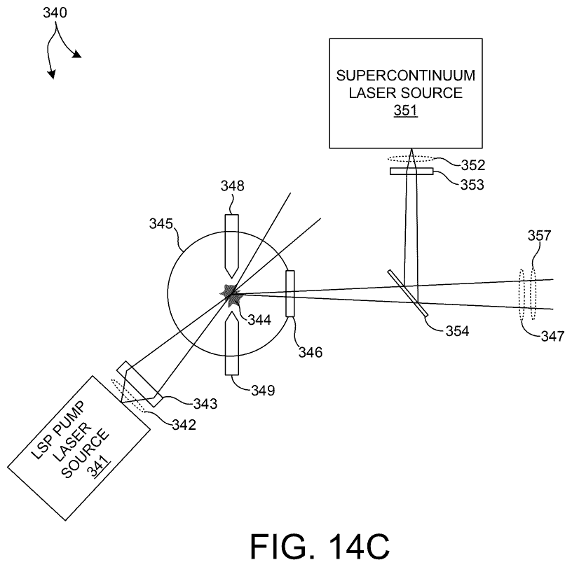

FIG. 14A depicts an embodiment 300 of a combined illumination source 140. As depicted in FIG. 14A, a voltage provided across a cathode 308 and an anode 309 generates a plasma 304 contained by bulb 305. In addition, a LSP pump laser source 301 generates pump light 302 that is focused by focusing optics 303 to sustain plasma 304 contained by bulb 305. Plasma 304 generates broadband spectrum light over a wavelength range of ultra-violet to short infrared. Ultraviolet/visible/short infrared light 307 generated by plasma 304 is provided to the illumination optics subsystem as described with reference to FIG. 1. In addition, supercontinuum laser source 311 generates infrared light 312. Infrared light 312 is focused by focusing lens 313 and forms a focus 314 at or near plasma 304. Infrared light 317 from focus 314 is provided to the illumination optics subsystem as described with reference to FIG. 1. In one example, UV/visible/short infrared light 307 and infrared light 317 are co-located and are effectively combined. In some examples, bulb 305 is constructed from Calcium Fluoride or Magnesium Fluoride to transmit wavelengths above 2.5 micrometers generated by supercontinuum laser source 311. In some other examples, bulb 305 includes one or more exit ports 306 fabricated from Calcium Fluoride or Magnesium Fluoride to transmit wavelengths above 2.5 micrometers generated by supercontinuum laser source 311. A conventional bulb constructed from fused silica does not transmit significant light above 2.5 micrometers, and is thus unsuitable for combining light generated by the supercontinuum laser illumination source 311 in the manner described herein.

FIG. 14B depicts an embodiment 320 of a combined illumination source 140. As depicted in FIG. 14B, a voltage provided across a cathode 328 and an anode 329 generates a plasma 324 contained by bulb 325. In addition, a LSP pump laser source 321 generates pump light 322 that is focused by focusing optics 323 to sustain plasma 324 contained by bulb 325. Plasma 324 generates broadband spectrum light over a wavelength range of ultra-violet to short infrared. Ultraviolet/visible/short infrared light 327 generated by plasma 324 exits bulb 325 through exit port 326 and is provided to the illumination optics subsystem as described with reference to FIG. 1. In addition, supercontinuum laser source 331 generates infrared light 332. Infrared light 332 is focused by focusing lens 333. Infrared light 337 from supercontinuum laser source 331 is provided to the illumination optics subsystem as described with reference to FIG. 1.

As depicted in FIG. 14B, UV/visible/short infrared light 327 and infrared light 337 are combined by beam combiner 334. As such, beam combiner 334 combines light generated by an ultraviolet light source 321 (e.g., LSP light source 321) with light generated by an infrared light source 331 (e.g., supercontinuum laser light source 331). In one example, the beam combiner 334 has a splitting wavelength, for example, at or near 900 nanometers. The beam combiner minimizes loss of light generated by the LSP light source (LSP loss less than 10%) and minimizes depolarization effects (e.g., less than 0.1%) across all illumination wavelengths.

FIG. 14C depicts an embodiment 340 of a combined illumination source 140. As depicted in FIG. 14C, a voltage provided across a cathode 348 and an anode 349 generates a plasma 344 contained by bulb 345. In addition, a LSP pump laser source 341 generates pump light 342 that is focused by focusing optics 343 to sustain plasma 344 contained by bulb 345. Plasma 344 generates broadband spectrum light over a wavelength range of ultra-violet to short infrared. Ultraviolet/visible/short infrared light 347 generated by plasma 344 exits bulb 345 through exit port 346 and is provided to the illumination optics subsystem as described with reference to FIG. 1. In addition, supercontinuum laser source 351 generates infrared light 352. Infrared light 352 is focused by focusing lens 353. Infrared light 357 from supercontinuum laser source 351 is provided to the illumination optics subsystem as described with reference to FIG. 1.

As depicted in FIG. 14C combined illumination source 140 provides ultraviolet and infrared illumination light to wafer 120 selectively. In these examples, the measurement is time multiplexed. Mirror 354 is a moveable mirror. In one example, moveable mirror 354 is mounted to a galvanometer employed to selectively direct ultraviolet/visible light 347 and infrared light 357 to wafer 120 based on whether moveable mirror 354 is locating in or out of the optical path of ultraviolet/visible light 347. In another example, a moveable total internal reflection prism is employed to selectively direct ultraviolet/visible light 347 and infrared light 357 to wafer 120. In this manner, spectral measurements including ultraviolet/visible spectra are performed at a different time than spectral measurements including infrared spectra.

In some embodiments, a multiple angle measurement system employs an illumination source that includes one or more spatially and temporally coherent, high-brightness illumination sources. A coherent, high-brightness illumination source enables high spectral intensity, and thus good signal to noise ratio at high throughput across the range of wavelengths from 170 nanometers to 2,000 nanometers, 170 nanometers to 2,500 nanometers, or greater.

In some embodiments, a multiple angle measurement system includes a spatially and temporally coherent, high-brightness supercontinuum laser illumination source, a spatially and temporally coherent, high-brightness mid-Infrared laser illumination source, e.g., a Frequency-Comb based source, or both. The mid-IR laser illumination source generates illumination in a range of wavelengths from 5 micrometers to 15 micrometers. The combination of a supercontinuum laser source and a mid-IR laser illumination source effectively extends the spectral range of the multi-angle measurement system from 400 nanometers to 5 -15 micrometers.

As depicted in FIG. 1, illumination light 141 is shaped by beam shaping optical element 142. In the embodiment depicted in FIG. 1, beam shaping optical element 142 is a condensing lens that captures and collimates illumination light 141 generated by illumination source 140 over an available illumination numerical aperture. In general, any suitable combination of beam shaping optics may be employed to capture the available illumination numerical aperture and collimate the captured light or focus the captured light at a pupil plane.

As depicted in FIG. 1, the captured illumination light 141 passes through illumination pupil aperture 143 located in the optical path of illumination light 141 at a location where the illumination pupil is spatially dispersed across the cross-section of the illumination light 141. Illumination pupil aperture 143 includes one or more apertures that select different portions of the available illumination NA from illumination light 141.

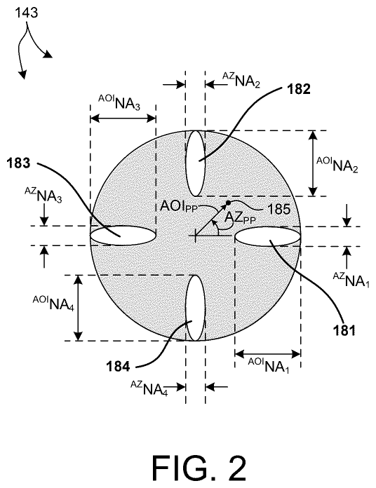

FIG. 2 is a simplified diagram illustrative of an illumination pupil aperture 143 in one embodiment. As illustrated in FIG. 2, the available numerical aperture at the illumination pupil can be characterized in polar coordinates, i.e., the radial coordinate value corresponds to the angle of incidence, AOI_{PP}, and the angular coordinate value corresponds to the azimuth angle, AZ_{PP}, associated with a given location in the illumination pupil, e.g., pupil plane location 185 illustrated in FIG. 2. In the embodiment depicted in FIG. 2, illumination pupil aperture 143 includes four apertures 181-184. Each transmits a different portion of the illumination pupil. The remaining area of illumination pupil aperture 143 (the shaded area) effectively blocks the remaining portions of the available illumination pupil. As depicted in FIG. 2, aperture 181 is characterized by a numerical aperture in the azimuth direction, ^{AZ}NA₁, and a numerical aperture in the angle of incidence direction, ^{AOI}NA₁. Similarly, aperture 182 is characterized by a numerical aperture in the azimuth direction, ^{AZ}NA₂, and a numerical aperture in the angle of incidence direction, ^{AOI}NA₂. Similarly, aperture 183 is characterized by a numerical aperture in the azimuth direction, ^{AZ}NA₃, and a numerical aperture in the angle of incidence direction, ^{AOI}NA₃. Similarly, aperture 184 is characterized by a numerical aperture in the azimuth direction, ^{AZ}NA₄, and a numerical aperture in the angle of incidence direction, ^{AOI}NA₄. In the embodiment depicted in FIG. 2, illumination pupil aperture 143 selects four different regions of the illumination pupil with the same numerical aperture in both the Az and AOI directions, each centered about a different nominal azimuth angle in the illumination pupil plane. In this manner, illumination pupil aperture 143 captures photons over identical ranges of Az and AOI from four different portions of illumination beam 141. In this manner, more photons of illumination beam 141 are made available to illuminate a specimen, and fewer photons are wasted, compared to traditional pupil selection schemes, which only transmit light from a single region of the illumination pupil.

In general, the apertures of illumination pupil aperture 143 may be arranged in any suitable configuration. In some embodiments, different apertures of illumination pupil aperture 143 have different shapes, and thus select different numerical apertures in the Az direction, the AOI direction, or both. In this manner, illumination light directed to different measurement channels has a numerical aperture in the Az and AOI directions that is tuned to the measurement application associated with each measurement channel.

In some embodiments, the illumination numerical aperture associated with one or more measurement channels is greater than 15 degrees in the AOI direction. In some embodiments, the illumination numerical aperture associated with all of the measurement channels is greater than 15 degrees in the AOI direction.

As depicted in FIG. 1, optical elements 146, 149, and 151 divide the portion of illumination light 141 transmitted through illumination pupil aperture 143 into four spatially separated illumination beams. In the embodiment depicted in FIG. 1, each spatially separated illumination beam corresponds to light transmitted through a different aperture, e.g., apertures 181-184, of illumination pupil aperture 143. As depicted in FIG. 1, optical element 146 is a mirror element that divides illumination beam 161 from illumination light 141, optical element 151 is a mirror element that divides illumination beam 164 from illumination light 141, and beam splitter 149 divides illumination beams 162 and 163 from illumination light 141.

As depicted in FIG. 1, additional optical elements, e.g., mirrors, lenses, or both, are located in the optical paths of one or more of illumination beams 161-164 to direct each illumination beam toward the same measurement location on wafer 120, each at different nominal azimuth angles with respect to wafer 120. In the embodiment depicted in FIG. 1, mirror elements 147 and 148 direct illumination beam 161 from pick-off mirror 146 to illumination optics 1A, which, in turn, focus illumination beam 161 onto measurement spot 116 on wafer 120 at a nominal azimuth angle at the wafer, AZ_{W} of 135 degrees. Similarly, mirror elements 152 and 153 direct illumination beam 164 from pick-off mirror 151 to illumination optics 4A, which, in turn, focus illumination beam 164 onto measurement spot 116 on wafer 120 at a nominal azimuth angle at the wafer, AZ_{W} of 270 degrees. Illumination beam 162 propagates from beams splitter 149 to illumination optics 2A, which, in turn, focus illumination beam 162 onto measurement spot 116 on wafer 120 at a nominal azimuth angle at the wafer, AZ_{W} of 180 degrees. Mirror 150 directs illumination beam 163 from beams splitter 149 to illumination optics 3A, which, in turn, focus illumination beam 163 onto measurement spot 116 on wafer 120 at a nominal azimuth angle at the wafer, AZ_{W} of 225 degrees.

In the embodiment depicted in FIG. 1, detector 1C generates output signals 171 indicative of detected light collected by collection optics 1B from measurement spot 116 in response to illumination beam 161 incident at measurement spot 116. Similarly, detector 2C generates output signals 172 indicative of detected light collected by collection optics 2B from measurement spot 116 in response to illumination beam 162 incident at measurement spot 116. Similarly, detector 3C generates output signals 173 indicative of detected light collected by collection optics 3B from measurement spot 116 in response to illumination beam 163 incident at measurement spot 116. In addition, detector 4C generates output signals 174 indicative of detected light collected by collection optics 4B from measurement spot 116 in response to illumination beam 164 incident at measurement spot 116.

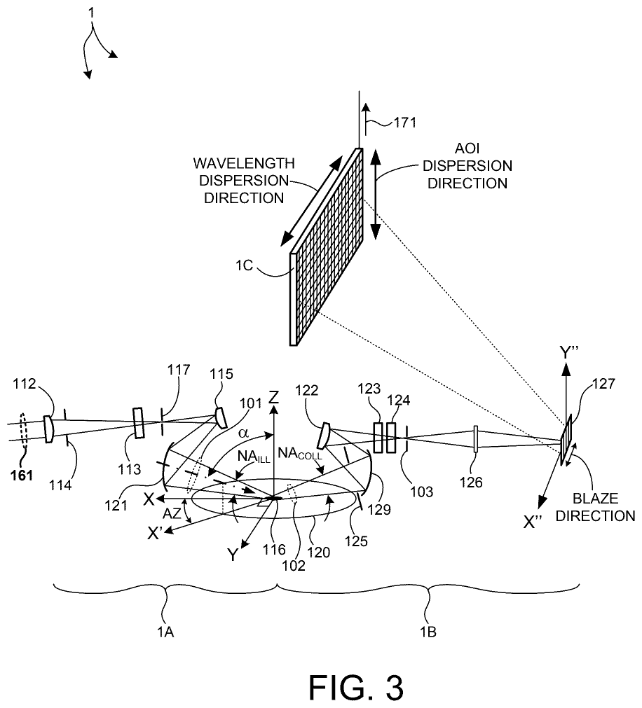

FIG. 3 is a diagram illustrative of measurement channel 1 of multi-angle measurement system 100 in one embodiment. In the embodiment depicted in FIG. 3, measurement channel 1 is configured as a spectroscopic ellipsometer. As depicted in FIG. 3, measurement channel 1 includes illumination optics 1A configured to direct illumination beam 161 to one or more structures formed on the wafer 120 over a range of angles of incidence and a range of azimuth angles. The illumination subsystem may include any type and arrangement of optical filter(s), polarizing component, field stop, pupil stop, etc., known in the art of spectroscopic metrology, including spectroscopic ellipsometry. As depicted in FIG. 3, the illumination optics 1A includes beam shaping optics 112, 115, and 121, polarizing component 113, and pupil stop 114. As depicted, in FIG. 3, the beam of illumination light 161 propagates to wafer 120 in an optical path including beam shaping optics 112, 115, and 121, and passes through polarizing component 113 and pupil stop 114. Beam 161 illuminates a portion of wafer 120 over a measurement spot 116 over a range of angles of incidence and a range of azimuth angles.

In the embodiment depicted in FIG. 1, pupil stop 114 controls the numerical aperture of the illumination at the wafer (NA_{ILL}) and may include any suitable commercially available aperture stop. In some embodiments, the illumination subsystem is configured to direct illumination light 101 to wafer 120 with an illumination Numerical Aperture (NA) of less than 0.15. In some of these embodiments, the illumination NA provides an illumination spot at wafer 120 that fits within a scribe line. This enables measurements of scribe line metrology targets.

In some embodiments the numerical aperture of the illumination at the wafer is defined by a coherent, laser based illumination source or a pupil aperture located in the path of illumination light before entry into illumination optics 1A, e.g., illumination pupil aperture 143 depicted in FIG. 1. However, in general, a pupil stop may also be included in the illumination optics associated with an individual measurement channel to further refine the illumination NA at the wafer. In this sense pupil stop 114 is optional.

As depicted in FIG. 3, illumination light 161 is incident at measurement spot 116 over a range of angles of incidence (AOI) and a range of azimuth angles (Az). In the embodiment depicted in FIG. 3, illumination light 101 is incident at wafer 120 at over a range of angles of incidence including a nominal angle of incidence, α, at or near 65 degrees from normal incidence. In addition, illumination light 101 is incidence at wafer 120 over a range of angles of incidence. As illustrated in FIG. 3, the azimuth angle is the angle between the projection of the nominal angle of incidence on the wafer surface, depicted as the X′ axis, and a reference axis co-planar with the wafer surface, depicted as the X axis.

In addition, the illumination subsystem may include filters, masks, apodizers, etc. For example, the illumination subsystem may include an illumination field stop (not shown) and one or more optical filters (not shown). The illumination field stop controls the field of view (FOV) of the illumination subsystem and may include any suitable commercially available field stop. The optical filters are employed to control light level, spectral output, or both, from the illumination subsystem. In some examples, one or more multi-zone filters are employed as optical filters. As depicted in FIG. 3, beam shaping optics 112, 115, and 121, include one or more optical elements having reflective focusing power.

In some examples, the beam size of the amount of illumination light 161 projected onto the surface of wafer 120 is smaller than a size of a measurement target that is measured on the surface of the specimen. Exemplary beam shaping techniques are described in detail in U.S. Patent Application Publication No. 2013/0114085 by Wang et al., the contents of which are incorporated herein by reference in their entirety.

In some examples, noise and polarization optimization are performed to improve the optical performance characteristics of illumination beam 161. In some examples, depolarization is achieved by use of multimode fibers, a Hanle depolarizer, or an integration sphere. In some examples, the illumination source etendue is optimized by use of light guides, fibers, and other optical elements (e.g., lenses, curved mirrors, apodizers, etc.).

Polarizing component 113 generates the desired polarization state exiting illumination optics 1A. In some embodiments, the polarizing component includes a polarizer, a compensator, or both, and may include any suitable commercially available polarizing component. The polarizer, compensator, or both, can be fixed, rotatable to different fixed positions, or continuously rotatable. Although illumination optics 1A depicted in FIG. 3 includes one polarizing component, the illumination subsystem may include more than one polarizing component. In some embodiments, a polarizer of polarizing component 113 is a Magnesium Fluoride Rochon polarizer. In some embodiments, a compensator of polarizing component 113 includes a quartz waveplate, a Magnesium Fluoride waveplate, a Calcium Fluoride K-prism, a Calcium Fluoride double Fresnel rhomb, or any combination thereof. In some embodiments, a compensator of polarizing component 113 includes one or more waveplates. In some of these embodiments, a first waveplate includes a desired retardation over a first wavelength range and a second waveplate includes a desired retardation over a second wavelength range, etc.

In some embodiments the polarization of illumination beam 161 incident on wafer 120 is defined by a coherent, laser based illumination source or one or more polarizing elements in the path of illumination light before entry into illumination optics 1A, e.g., polarizing elements 144 and 145 depicted in FIG. 1. However, in general, polarizing component 113 may also be included in the illumination optics associated with an individual measurement channel to further refine the illumination polarization at the wafer. In this sense polarizing component 113 is optional.

Measurement channel 1 also includes collection optics 1B configured to collect light generated by the interaction between the one or more structures and the incident illumination beam 161 over a range of collection angles of incidence and a range of collection azimuth angles. Moreover, collection optics 1B focuses the collected light at or near a dispersive element, e.g., a spectrometer slit, of a spectrometer. Collection optics 1B may include any type and arrangement of optical filter(s), polarizing component, field stop, pupil stop, etc., known in the art of spectroscopic metrology. In some embodiments, collection optics 1B includes a field stop, a pupil mask, and one or more optical elements having reflective focusing power.

As depicted in FIG. 3, a beam of collected light 102 is collected from measurement spot 116 by collection optics 1B. Collected light 102 is reflected from beam shaping optics 129, 122, and 126, and passes through compensator 123, analyzer 124, collection mask 125, and collection field stop 103 of collection optics 1B as the beam of collected light 102 propagates from wafer 120 to dispersive element 127 of the spectrometer.

As depicted in FIG. 3, collection optics 1B includes a polarizing component that analyzes the polarization state of the collected light. In some embodiments, the polarizing component includes an analyzer, a compensator, or both, and may include any suitable commercially available polarizing component. The analyzer, compensator, or both, can be fixed, rotatable to different fixed positions, or continuously rotatable. Collection optics 1B depicted in FIG. 3 includes a compensator 123 and an analyzer 124. In general, collection optics 1B may include any number of polarizing elements.

In some embodiments, compensator 123 includes a quartz waveplate, a Magnesium Fluoride waveplate, a Calcium Fluoride K-prism, a Calcium Fluoride double Fresnel rhomb, or any combination thereof. In some embodiments, compensator 123 includes one or more waveplates. In some of these embodiments, a first waveplate includes a desired retardation over a first wavelength range and a second waveplate includes a desired retardation over a second wavelength range, etc. In some embodiments, analyzer 124 is a Magnesium Fluoride Rochon analyzer.

As depicted in FIG. 3, collection optics 1B includes a collection mask 125 disposed at or near a pupil of the collection optics subsystem. Collection mask 125 includes an aperture, i.e., opening, configured to select and transmit collected light within a range of collection angles defined by a collection numerical aperture (NA). The range of collection angles corresponds to some or all of the range of angles of incidence about the nominal angle of incidence defined by the illumination NA and some or all of the range of azimuth angles.

Collection field stop 103 controls the field of view of the collection optics subsystem. In some other embodiments, a slit at or near dispersive element 127, e.g., a spectrometer slit, is employed to define the field of view of the collection optics subsystem.

In the embodiment depicted in FIG. 3, a spectrometer includes the collection field stop 103, dispersive element 127, and focusing optics 126. In some embodiments (not shown), focusing optics 126 are a set of one or more optics having reflective focusing power. The collection field stop 103 receives light from the collection optics, and transmits a portion of the collected light to dispersive element 127. Dispersive element 127 is typically located at or near an image plane of the measurement pupil. In the embodiment depicted in FIG. 3, light from collection mask 125 is imaged from collection mask 125 to the pupil plane at or near dispersive element 127.

Dispersive element 127 disperses the collected light according to wavelength over a range of wavelengths. In the embodiment depicted in FIG. 3, dispersive element 127 is a reflective grating. However, in general, any suitable dispersive element may be contemplated within the scope of this patent document. By way of non-limiting example, a dispersive element may be a reflective grating structure, a transmissive grating structure, a dispersive prism structure, etc. In some examples, a dispersive element is a planar diffraction grating. In other examples, a dispersive element is a parabolic diffraction grating.

As depicted in FIG. 3, dispersive element 127 receives light from collection mask 125 that corresponds to a range of collection angles defined by the collection NA, which, in turn, correspond to a range of angles of incidence and a range of azimuth angles. In some embodiments, dispersive element 127 is configured with a broad entrance angle that simultaneously disperses the collected light according to wavelength in one direction and according to AOI (or Az) in the orthogonal direction. In these embodiments, dispersive element 127 disperses the collected light across the active surface of a detector in two dimensions. In some of these embodiments, the range of angles of incidence dispersed across the detector is defined by the collection NA. In other embodiments, dispersive element 127 disperses the collected light according to wavelength across the active surface of the detector along one direction, and disperses the collected light according to azimuth angle across the active surface of the detector along another direction. In some of these embodiments, the range of azimuth angles dispersed across the detector is defined by the collection NA.

As depicted in FIG. 3, measurement channel 1 includes at least one detector, e.g., detector 1C, having a planar, two-dimensional surface sensitive to incident light. Detector 1C is selected for signal to noise ratio performance and fast read-out. Detector 1C detects the amount of collected light and generates output signals 171 indicative of the detected light. The collected light is dispersed onto detector 1C according to wavelength along a wavelength dispersion direction of the at least one detector and according collection angle along a second direction of the at least one detector, e.g., over the range of collection angles of incidence or the range of collection azimuth angles. In a preferred embodiment, the first and second directions are orthogonal. Detector 1C resolves the collected light into discrete wavelengths along one direction and resolves the collected light into discrete collection angles along another direction.

In a further aspect, detector 1C generates an image indicative of the detected light resolved in wavelength and AOI or wavelength and Az. In the embodiment depicted in FIG. 3, detector 1C, each image detected by detector 1C includes photon intensity data resolved in wavelength in the X-direction and AOI in the Y-direction.

As illustrated in FIG. 1, a multi-angle measurement system, e.g., multi-angle measurement system 100, simultaneously collects signal information from a measured structure at multiple nominal azimuth angles, each associated with a different measurement channel. In addition, illumination beams 161-164 are incident on wafer 120 over a range of angles of incidence defined by the numerical aperture of each illumination beam in the AOI direction as defined by illumination pupil aperture 143. In addition, illumination beams 161-164 are incident on wafer 120 over a range of azimuth angles defined by the numerical aperture of each illumination beam in the AZ direction as defined by illumination pupil aperture 143. In this manner, the signal information simultaneously collected from a measured structure by a multi-angle measurement system can be quite extensive, and specifically tuned to each measurement application.

In the embodiment depicted in FIG. 3, one or more measurement channels of a multi-angle measurement system are configured as a spectroscopic ellipsometer configured to simultaneously resolve detected light in wavelength and collection angle, e.g., AOI or Az, about the nominal azimuth angle associated with each of the one or more measurement channels. However, in general, each measurement channel of a multi-angle measurement system may be configured in any suitable measurement configuration, e.g., spectroscopic ellipsometer, spectroscopic reflectometer, discrete wavelength ellipsometer, rotating polarizer ellipsometer, rotating compensator ellipsometer, rotating polarizer rotating compensator ellipsometer, Mueller-matrix ellipsometer, spectrally resolved polarimeter, interferometer, etc.

As depicted in FIG. 1, multi-angle measurement system 100 includes four measurement channels, simultaneously collecting measurement data, each at different nominal azimuth angles. However, in general, multi-angle measurement system may include two or more measurement channels, simultaneously collecting measurement data, each at different nominal azimuth angles. Moreover, each measurement channel may be configured similarly or differently than any other measurement channel.

In some other embodiments, at least one measurement channel of multi-angle measurement system is illuminated by illumination light generated by a different illumination source than other measurement channels.

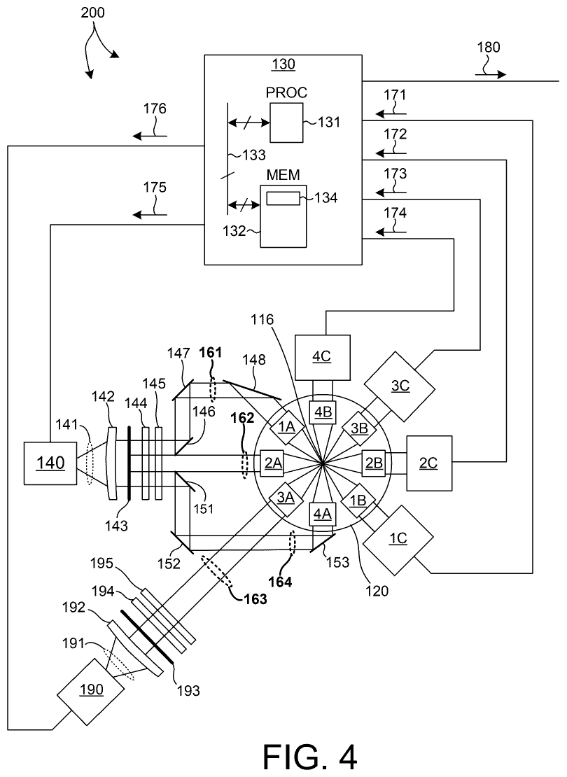

FIG. 4 is a simplified diagram illustrative of a multi-angle measurement system 200 in another embodiment. Like numbered elements depicted in FIG. 4 are analogous to those described with reference to FIG. 1. In the embodiment depicted in FIG. 4, illumination light 141 is divided into three illumination beams 161 162, and 164 directed to measurement channels 1, 2, and 4, respectively. However, illumination beam 163 directed to measurement channel 3 is generated by a different illumination source. As depicted in FIG. 4, multi-angle measurement system 200 includes an illumination source 190 that generates an amount of illumination light 191 including a range of wavelengths.

As depicted in FIG. 4, illumination light 191 is shaped by beam shaping optical element 192. In the embodiment depicted in FIG. 4, beam shaping optical element 192 is a condensing lens that captures and collimates illumination light 191 generated by illumination source 190 over an available illumination numerical aperture. In general, any suitable combination of beam shaping optics may be employed to capture the available illumination numerical aperture and collimate the captured light or focus the captured light at a pupil plane.

As depicted in FIG. 4, the captured illumination light 191 passes through illumination pupil aperture 193 located in the optical path of illumination light 191 at a location where the illumination pupil is spatially dispersed across the cross-section of the illumination light 191. Illumination pupil aperture 193 includes one or more apertures that select one or more portions of the available illumination NA from illumination light 191.

In some embodiments, illumination source 190 generates broadband illumination in a range of wavelengths within the deep ultraviolet (DUV) portion of the electromagnetic spectrum. In this manner, measurement channel 3 is a DUV measurement channel.

In some embodiments, multi-angle measurement system includes at least one measurement channel that performs measurements at a single wavelength. In one embodiment, illumination source 190 is a narrowband, laser based illumination source that generates single wavelength illumination light directed to measurement channel 3.

In another aspect, at least one measurement channel of a multi-angle measurement system performs measurements over a different spectral range than another measurement channel of the multi-angle measurement system. In some embodiments, a different illumination source is employed to generate illumination light employed by one measurement channel at a different spectral range than another measurement channel. In some other embodiments, the same illumination source is employed to generate illumination light employed by one measurement channel at a different spectral range than another measurement channel. In some of these embodiments, different spectral filters are employed in one or both of the illumination beam paths of two different measurement channels to provide illumination light at different spectral ranges to the two different measurement channels. In this manner, the spectral content of each measurement channel incident on the specimen under measurement at a different nominal azimuth angle may be optimized to enable high efficiency spectral channels with improved measurement sensitivity and signal to noise ratio at each corresponding nominal azimuth angle. In some embodiments, one or more of the mirror elements depicted FIGS. 1 and 4 are treated with dichroic coatings to spectrally filter the illumination beams 161-164 in the desired manner. In some embodiments, discrete optical filter components are included in the optical paths of any of illumination beams 161-164 to generate the desired spectral content in each measurement channel.

In some embodiments, illumination light in the infrared range of the electromagnetic spectrum is provided to at least one measurement channel and illumination light in the ultraviolet range, visible range, or both, is provided to at least one other measurement channel.

In another aspect, the measurement signals generated by at least one measurement channel of a multi-angle measurement system are resolved in polarization. In some embodiments, at least one polarizing element is located in the illumination beam path from the illumination source to the wafer to encode the illumination beam with polarization information. Changes in polarization due to interaction with the wafer under measurement are detected from the collected light captured at the detector.

In some embodiments, one or more rotating polarizing elements are disposed in the illumination beam path, the collection beam path, or both.

In some embodiments, one or more static polarizing elements are disposed in the illumination beam path, the collection beam path, or both. In the embodiment depicted in FIG. 1, a linear polarizer 144 and a quarter waveplate 145 are located in the path of illumination light 141. In this manner, illumination beams 161-164 are circularly polarized. In the embodiment depicted in FIG. 4, a linear polarizer 144 and a quarter waveplate 145 are located in the path of illumination light 141, and a linear polarizer 194 and a quarter waveplate 195 are located in the path of illumination light 191. In this manner, illumination beams 161-164 are circularly polarized. Static polarizing elements, such as the combination of a linear polarizer and a quarter waveplate, eliminate the potential for mechanical failure and particle generation associated with rotating elements. In addition, employing circular polarization, enables rapid acquisition of multiple polarization states without delays introduced by limited mechanical speeds.

In the embodiments depicted in FIGS. 1 and 4, polarizing elements are located in the optical beam path before beam separation into different measurement channels. However, in general, polarizing elements may be located anywhere in an optical beam path associated with any measurement channel between an illumination source and the wafer. For example, in the embodiment of measurement channel 1 depicted in FIG. 3, polarizing element 113 is employed after beam separation into different measurement channels.

In a further aspect, the measurement signals generated by at least one measurement channel of a multi-angle measurement system are simultaneously resolved in wavelength, collection angle, and polarization.

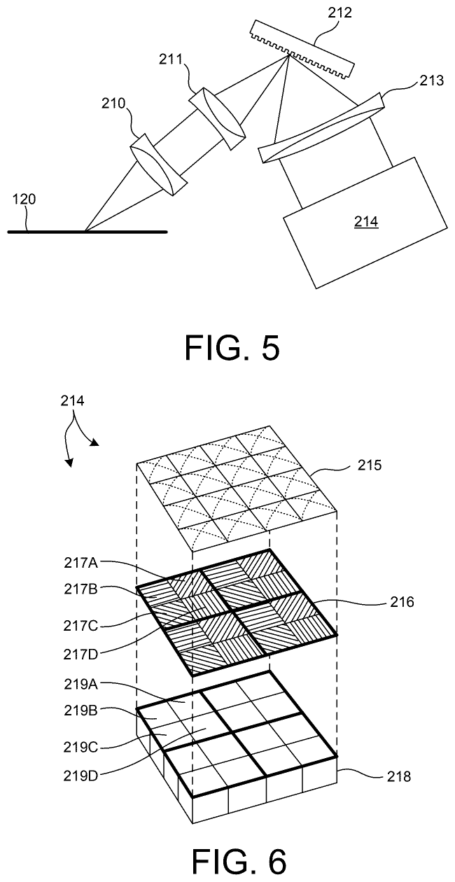

FIG. 5 is a simplified diagram illustrative of a spectrally resolved polarimeter that simultaneously detects measurement signals in wavelength, angle of incidence, and polarization. In the embodiment depicted in FIG. 5, light from wafer 120 is collected by collection optical elements 210 and 211 and focused onto dispersive element 212. Dispersive element 212 disperses the collected light according to wavelength in one direction and collection angle in an orthogonal direction. The dispersed light passed through collimating optic 213 and is incident on polarization pixelated camera 214, e.g. a polarization image sensor manufactured by Sony Semiconductor Solutions Group, Sony Group Corporation (Japan).

FIG. 6 is a simplified exploded view of polarization pixelated camera 214 in one embodiment. As depicted in FIG. 6, polarization pixelated camera 214 is an integrated device including a microlens array 215, stacked on a polarization layer 216, stacked on a pixel array 218. The pixel array is subdivided into many four-pixel groups. For example, pixels 219A-D are grouped together. The polarization layer includes corresponding groups of four different structured polarizers. For example, structured polarizers 217A-D each resolve a different polarization state, and each corresponds to pixels 219A-D, respectively. Microlens array 215 includes a focusing microlens corresponding to each four-pixel group of pixel array 218. In this manner, each four-pixel group resolves a different wavelength and collection angle, and within each four-pixel group of pixels, polarization information is simultaneously resolved into four different polarization states.

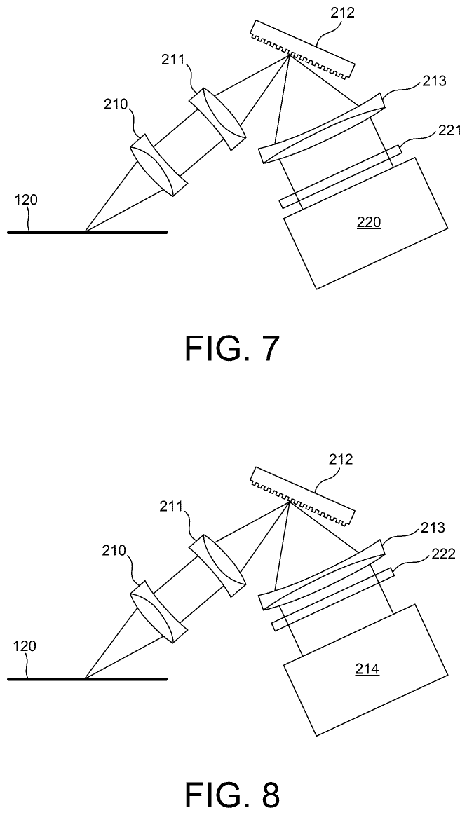

FIG. 7 is a simplified diagram illustrative of a spectrally resolved polarimeter that simultaneously detects measurement signals in wavelength, angle of incidence, and polarization in another embodiment. In the embodiment depicted in FIG. 7, light from wafer 120 is collected by collection optical elements 210 and 211 and focused onto dispersive element 212. Dispersive element 212 disperses the collected light according to wavelength in one direction and collection angle in an orthogonal direction. The dispersed light passes through collimating optic 213 and is incident on a structured polarizing element 221 analogous to polarizing layer 216 depicted in FIG. 6. Light analyzed by structured polarizing element 221 is projected onto a pixelated camera 220, e.g., a CMOS camera, an InGaAs camera, etc. In this manner, each multiple-pixel group resolves a different wavelength and collection angle, and within each multiple-pixel group of pixels, polarization information is simultaneously resolved into multiple different polarization states.

In some other embodiments, polarization is also resolved sequentially.

FIG. 8 is a simplified diagram illustrative of a spectrally resolved polarimeter that both simultaneously and sequentially detects measurement signals in wavelength, angle of incidence, and polarization in one embodiment. In the embodiment depicted in FIG. 8, light from wafer 120 is collected by collection optical elements 210 and 211 and focused onto dispersive element 212. Dispersive element 212 disperses the collected light according to wavelength in one direction and collection angle in an orthogonal direction. The dispersed light passes through collimating optic 213 and a rotary polarizing element 222. Light analyzed by rotary polarizing element 222 is projected onto polarization pixelated camera 214. In this manner, each four-pixel group resolves a different wavelength and collection angle, and within each four-pixel group of pixels, polarization information is simultaneously resolved into four different polarization states. This occurs at each image sample collected by detector 214. In addition, multiple image samples are collected, each at different rotational states of rotary polarizing element 222. In this manner, additional polarization resolved signal information is generated by detector 214.

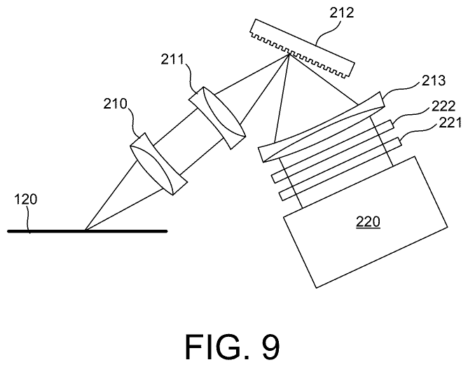

FIG. 9 is a simplified diagram illustrative of a spectrally resolved polarimeter that both simultaneously and sequentially detects measurement signals in wavelength, angle of incidence, and polarization in another embodiment. In the embodiment depicted in FIG. 9, light from wafer 120 is collected by collection optical elements 210 and 211 and focused onto dispersive element 212. Dispersive element 212 disperses the collected light according to wavelength in one direction and collection angle in an orthogonal direction. The dispersed light passes through collimating optic 213, rotary polarizing element 222 and structured polarizing element 221. Light analyzed by rotary polarizing element 222 and structured polarizing element 221 is projected onto pixelated camera 220. In this manner, each multiple-pixel group resolves a different wavelength and collection angle, and within each multiple-pixel group of pixels, polarization information is simultaneously resolved into multiple different polarization states. This occurs at each image sample collected by detector 220. In addition, multiple image samples are collected, each at different rotational states of rotary polarizing element 222. In this manner, additional polarization resolved signal information is generated by detector 220.

In some embodiments, a multi-angle measurement system includes one or more meta-optical elements, a.k.a., nano-photonic optical elements to encode polarization information in the illumination optical path and decode polarization information in the collection optical path. Meta-optical elements employ very small optical structures on the surface of one or more optical elements. The optical structures have dimensions less than the wavelength of measurement light. Meta-optical elements encode and decode complex polarization functions, and thus are not limited to a small number of static polarization states and are not limited by the time delays inherent to a sequential polarization scheme, such as rotary polarization.

As described herein, in some embodiments, a multi-angle measurement system simultaneously acquires measurement signal information resolved in wavelength, polarization state, collection angle, and nominal azimuth angle, without scanning or applying dynamic measurement sequences. This enables increased measurement throughput and measurement performance. In addition, by sharing one or more illumination sources among multiple measurement channels, the number of photons simultaneously delivered and collected from the wafer target is significantly increased compared to traditional measurement system architectures.

In some embodiments, one or more measurement channels of a multi-angle measurement system are configured in a legacy configuration. A legacy configuration is backward compatible with measurements performed in the past. This may be advantageous when integrating a multi-angle measurement system in a semiconductor process flow, e.g., for fleet matching purposes, historical measurement applications, etc.

In a further aspect, a computing system is configured to estimate values of one or more parameters of interest characterizing structural characteristics of a specimen under measurement based on measurement signals generated by at least two different measurement channels, each simultaneously detecting light collected from a common measurement spot in response to illumination light provided to the measurement spot at different nominal azimuth angles. In the embodiment depicted in FIG. 1, computing system 130 is configured to estimate values of one or more parameters of interest 180 characterizing structural characteristics of wafer 120 at measurement spot 116 based on measurement signals 171-174. In some embodiments, measurement signals 171-174 are each employed to estimate different parameters of interest. In this manner, the diversity of signal information provided by a multi-angle measurement system is employed to measure multiple parameters of interest simultaneously, thus improving throughput. However, in some embodiments, any combination of measurement signals 171-174 are employed to estimate the same parameter of interest. In this manner, signal information from multiple measurement channels may be combined to estimate values of one or more parameters of interest that would otherwise be impossible or inaccurately estimated based on measurement signals from a single measurement channel.

In some embodiments, computing system 130 configured to receive detected signals 171-174 including measurement data resolved over wavelength, collection angle, polarization, and nominal azimuth angle, and determine at least one estimated value 180 of at least one parameter of interest characterizing one or more structural characteristics of the measured structure(s) based on the detected measurement signals. In these examples, measurement data is not integrated, e.g., binning, across measurement data resolved in azimuth angle, angle of incidence, or both. This avoids loss of signal information inherent to integration. Rather, the measurement model operates on a measurement data set resolved in at least wavelength, azimuth angle, and angle of incidence, e.g., measurement data set includes measured photon intensity as a function of wavelength, azimuth angle, and angle of incidence.

In some embodiments, computing system 130 estimates values of one or more parameters of interest by regression on a physics-based measurement model. In other embodiments, computing system 130 estimates values of one or more parameters of interest based on a trained machine learning based measurement model.

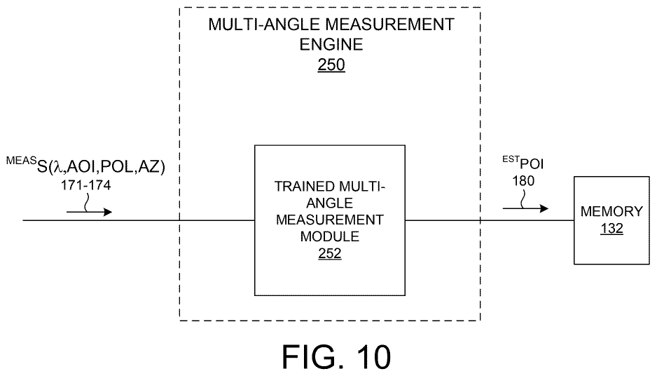

FIG. 10 is a diagram illustrative of a trained multi-angle measurement engine 250 in one embodiment. Multi-angle measurement engine 250 includes a trained multi-angle measurement model 252. As depicted in FIG. 10, a set of measured images resolved in wavelength, collection angle, polarization, and nominal azimuth angle, ^{MEAS}S(λ, AOI, POL, Az) 171-174, are provided as input to trained multi-angle measurement model 252. In response, trained multi-angle measurement model 252 estimates the value of at least one parameter of interest characterizing at least one structural characteristic of the specimen under measurement, ^{EST}POI 180, based on the set of measured images.

In a further aspect, a machine learning based multi-angle measurement model is trained based on multiple Design Of Experiments (DOE) measurements.

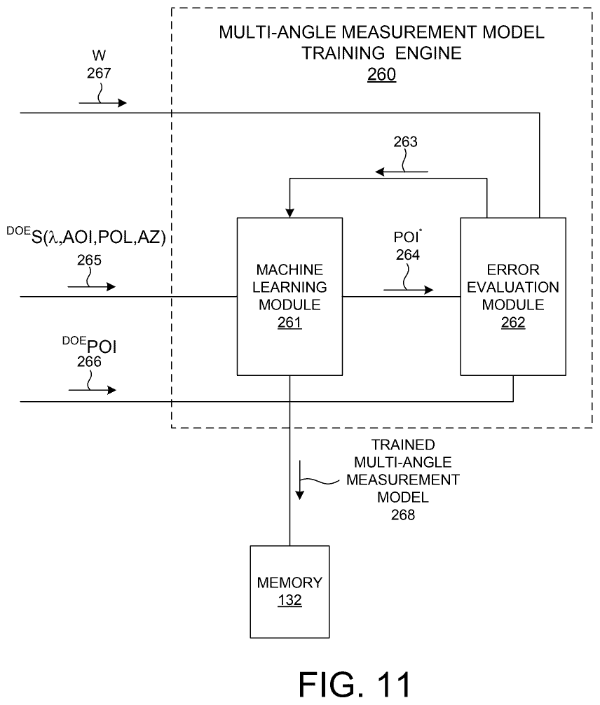

FIG. 11 is a diagram illustrative of a multi-angle measurement model training engine 260 implemented on any suitable computing system, e.g., computing system 130. As depicted in FIG. 11, a multi-angle measurement model training engine 260 includes a machine learning module 261 and an error evaluation module 262. Training data is communicated to multi-angle measurement model training engine 260. The training data includes a large number of DOE measurements including multiple images associated with an amount of collected light resolved over a range of wavelengths, collection angles, polarization states, and nominal azimuth angles, ^{DOE}S(λ, AOI, POL, AZ) 265, and a corresponding DOE values of one or more parameters of interest, ^{DOE}POI 266.

As depicted in FIG. 11, training data set 265 including multiple sets of collected images is communicated to machine learning module 261, and corresponding training data set 266 including corresponding values of one or more parameters of interest is communicated to error evaluation module 262.

In some examples, machine learning module 261 generates estimated values of one or more parameters of interest, POI* 264, based on each set of DOE images comprising the training data set 265. Error evaluation module 262 receives the estimated values of the one or more parameters of interest, POI* 264, generated by machine learning module 261. In addition, error evaluation module 262 receives training data set 266 including the corresponding values of the parameter of interest characterizing associated with each set of DOE images included in training data set 265. The values of training set 266 indicate trusted values of the one or more parameters of interest associated with each set of DOE images included in training data set 265. Error evaluation module 262 generates updated values of weighting parameters 263 of the machine learning model 261 undergoing training to minimize differences between the estimated values of the one or more parameters of interest, POI* 264, and the trusted values of the one or more parameters of interest associated with each set of measurement signals. In the next iteration of model training, new estimated values of the one or more parameters of interest, POI* 264, are generated by machine learning module 261 based on the values of the weighting parameters 263 generated in the previous iteration. The training process continues until the differences between the estimated values of the one or more parameters of interest, POI* 264, and the trusted values of the one or more parameters of interest associated with each set of measurement signals are acceptably small. At this point, the trained multi-angle measurement model 268 is stored in a memory, e.g., memory 132.

In some embodiments, training data set 265 includes measured images associated with a measurement of each of the plurality of instances of the semiconductor structure under measurement by a multi-angle measurement system, such as measurement system 100, and training data set 266 includes a corresponding measured value of the parameter of interest associated with a reference measurement of each of the plurality of instances of the semiconductor structure by a reference metrology system. Typically, the sets of measured images and corresponding reference measurements are derived from measurements of instances of the structure of interest fabricated on one or more Design Of Experiments (DOE) wafers. The DOE wafers are typically off-line wafers purposely fabricated with variations in process parameters to probe the expected process space and ensure that the measurement model is trained to reliably perform measurements of structures fabricated within the expected process window during high volume production.

For many process steps of a complex semiconductor structure, reliable, actual reference measurements are only available from low throughput, expensive, and often destructive measurement techniques, e.g., Transmission Election Microscopy (TEM), Scanning Electron Microscopy (SEM), etc. Thus, in practice, it is not feasible to generate very large reference data sets based on actual reference measurement data generated by trustworthy reference measurement systems for many process steps. In response, synthetically generated measurement data, i.e., generated by simulation, are employed to overcome the lack of actual reference measurement data collected at a limited number of different locations on a limited number of different wafers.

In a further aspect, multi-angle measurement model training engine 260 includes a weighting module (not shown) that assigns different weighting values to different sets of training data, e.g., any of the different set of training data depicted in FIG. 11. The relative weighting of different sets of training data emphasizes training data sets assigned a relatively high weighting and deemphasizes training data sets assigned a relatively low weighting. In this manner, training data sets associated with a higher level of trust in the data or higher correlation to the current version of the structure of interest in the present state are emphasized over training data sets that are less trusted or have lower correlation to the current version of the structure of interest in the present state.

In the example, depicted in FIG. 1, weighting values, W 267, are communicated to error evaluation module 262. In one example, actual reference measurement values, and corresponding measured images associated with measurement of the reference structures by a spectroscopic metrology system are assigned a relatively high weighting compared to synthetic training data for purposes of training. In general, any relative weighting among the training data sets may be contemplated within the scope of this patent document.

Multi-angle measurements of semiconductor structures resolved in wavelength, collection angle, polarization state, and nominal azimuth angle enable critical dimension measurements, shape and profile measurements, and film measurements of deep structures fabricated in accordance with current semiconductor fabrication nodes and those contemplated for fabrication at future semiconductor fabrication nodes. By way of non-limiting example, multi-angle measurements of semiconductor structures resolved in wavelength, collection angle, polarization state, and nominal azimuth angle enable measurements of features of 3D NAND memory structures having more than 300 layers, e.g., 300-1,000 layers, 3D DRAM memory structures greater than 10 micrometers deep, CMOS-based image sensors, power devices, semiconductor bonding through-silicon-via (TSV) structures, and micro-electro-mechanical structures (MEMS) with deep trenches and holes, e.g., 20 millimeter, or deeper, 100 millimeters, or deeper, etc.

In some embodiments, the methods and systems for spectroscopic metrology of semiconductor devices described herein are applied to the measurement of high aspect ratio (HAR), large lateral dimension structures, opaque film layers, or a combination thereof. These embodiments enable optical critical dimension (CD), film, and composition metrology for semiconductor devices with HAR structures (e.g., NAND, VNAND, TCAT, DRAM, etc.) and, more generally, for complex devices that suffer from low light penetration into the structure(s) being measured. HAR structures often include hard mask layers to facilitate etch processes for HARs. As described herein, the term “HAR structure” refers to any structure characterized by an aspect ratio that exceeds 2:1 or 10:1, and may be as high as 100:1, or higher.

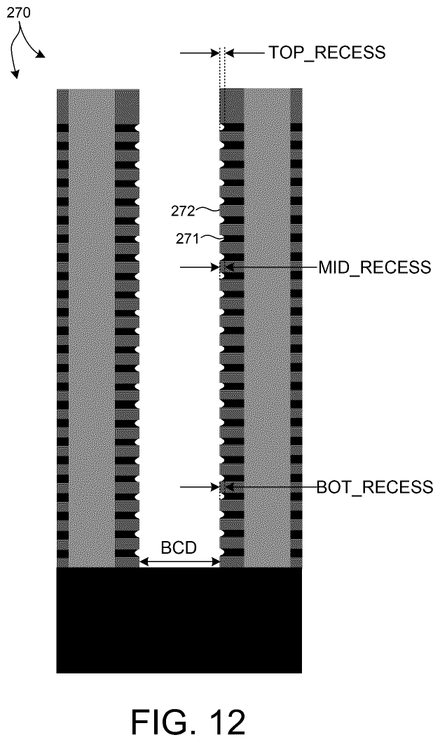

FIG. 12 depicts a vertically integrated memory structure 270 including tungsten layers 271 sandwiched between oxide layers 272. As depicted in FIG. 12, the etching process leaves behind a horizontal recess in each tungsten layer 271 relative to oxide layers 272 above and below each tungsten layer 271. The tungsten recess at or near the top of structure 270 is referred to as a top_recess. The tungsten recess at or near the middle of structure 270 is referred to as a mid_recess. The tungsten recess at or near the bottom of structure 270 is referred to as a bot_recess. The opening of the oxide layer 272 at or near the bottom of structure 270 is referred to as the bottom critical dimension (BCD).

In some embodiments, a multi-angle measurement system includes a combined illumination source including a supercontinuum laser illumination source and a MID-IR laser illumination source. The combined illumination source generates illumination light having wavelengths down to 400 nanometers. In some examples, the combined illumination source generates illumination light having wavelengths up to and including 4.2 micrometers. In some examples, the combined illumination source generates illumination light having wavelengths up to and including 5 micrometers. In some examples, the combined illumination source generates illumination light having wavelengths that exceed 5 micrometers.

In general, a collection optics subsystem may direct light to more than one detector. In these embodiments, two or more detectors are each configured to detect collected light over different wavelength ranges, simultaneously.

In one example, one detector is a charge coupled device (CCD) sensitive to ultraviolet and visible light (e.g., light having wavelengths between 190 nanometers and 860 nanometers), and another detector is a photo detector array (PDA) sensitive to infrared light (e.g., light having wavelengths between 950 nanometers and 5000 nanometers). However, in general, other two dimensional detector technologies may be contemplated (e.g., a position sensitive detector (PSD), an infrared detector, a photovoltaic detector, etc.). Each detector converts the incident light into electrical signals indicative of the spectral intensity of the incident light.

In general, a dispersive element, e.g., dispersive element 127, may be configured to subdivide incident light into different wavelength bands, propagate the different wavelength bands in different directions, and disperse the light of one of the wavelength bands onto one or more detectors in any suitable manner. In one example, dispersive element 127 is configured as a transmissive grating. In some other examples, dispersive element 127 includes a beamsplitting element to subdivide the beam into different wavelength bands and a reflective or transmissive grating structure to disperse one of the wavelength bands onto a detector.

In some embodiments, dispersive element 127 is a reflective grating configured to diffract a subset of wavelengths of the incident light into the +/−1 diffraction order toward one detector and diffract a different subset of wavelengths of the incident light into the zero diffraction order toward another detector.

By measuring a target with infrared, visible, and ultraviolet light in a single system, precise characterization of complex three dimensional structures is enabled. In general, relatively long wavelengths penetrate deep into a structure and provide suppression of high diffraction orders when measuring structures with relatively large pitch. Relatively short wavelengths provide precise dimensional information about structures such as relatively small CD and roughness features. In some examples, longer wavelengths enable measurement of dimensional characteristics of targets with relatively rough surfaces or interfaces due to lower sensitivity of longer wavelengths to roughness. In general, measuring a target with infrared, visible, and ultraviolet light in a single system improves sensitivity to some measurement parameters and reduces correlations among parameters (e.g., parameters characterizing top and bottom layers).

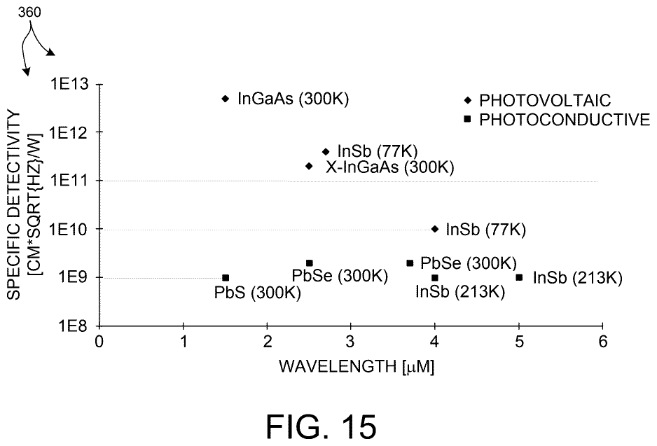

FIG. 15 depicts a plot 360 illustrative of the specific detectivity of various detector technologies operating at specified temperatures. As illustrated in FIG. 15, both photovoltaic and photoconductive detector technologies are suitable for detecting radiation at infrared wavelengths exceeding one micrometer, and up to five micrometers. In some examples, measurement system 100 include detectors such as lead sulfide (PbS), lead selenide (PbSe), indium antimonide (InSb), indium arsenide (InAs), mercury cadmium telluride (HgCdTe), indium gallium arsenide (InGaAs), x-InGaAs, pyroelectric, and bolometric detectors.

Pyroelectric and bolometric detectors are not quantum detectors. Thus, these detectors may accept high light levels without saturation, and thus reduce noise sensitivity.

In some embodiments, the detector subsystem is shot noise limited, rather than dark noise limited. In these examples, it is preferred to perform multiple measurements at high light levels to reduce measurement system noise.

In some embodiments, a time dependent measurement (e.g., pulsed light source, chopper, etc.) is performed in coordination with a lock-in amplifier or other phase locked loop to increase the measurement signal to noise ratio.

In some embodiments, one or more of the detectors are cooled to temperatures of −20° C., 210° K, 77° K, or other low temperature to reduce measurement noise. In general, any suitable cooling element may be employed to maintain the temperature of a detector at a constant temperature during operation. By way of non-limiting example, any of a multi stage Peltier cooler, rotating disc cooler, Stirling cycle cooler, N2 cooler, He cooler, etc. may be contemplated within the scope of this patent document.

In some embodiments, a broad range of wavelengths are detected by a detector that includes multiple photosensitive areas having different sensitivity characteristics. Collected light is linearly dispersed across the surface of the detector according to wavelength in one direction and according to collection angle in another direction. Each different photosensitive area is arranged on the detector to sense a different range of incident wavelengths. In this manner, a broad range of wavelengths are detected with high signal to noise ratio by a single detector. These features, individually, or in combination, enable high throughput measurements of high aspect ratio structures (e.g., structures having depths of one micrometer or more) with high throughput, precision, and accuracy.

In some embodiments, a detector subsystem includes a multi-zone infrared detector that combines different sensitivity bands at different locations on a single detector package. The detector is configured to deliver a continuous spectrum of data at different sensitivities, depending on location of incidence.

FIG. 17 illustrates typical photosensitivity curves of available Indium Gallium Arsenide (InGaAs) sensors. As depicted in FIG. 17, no single sensor of the available InGaAs sensors is capable of providing adequate photosensitivity across a wavelength band from 1 micrometer to 2.5 micrometers. Thus, individually, the available sensors are only capable of sensing over a narrow waveband.

In some embodiments, multiple sensor chips, each sensitive in a different waveband are combined into a single detector package. In turn, this multi-zone detector is implemented in the metrology systems described herein.

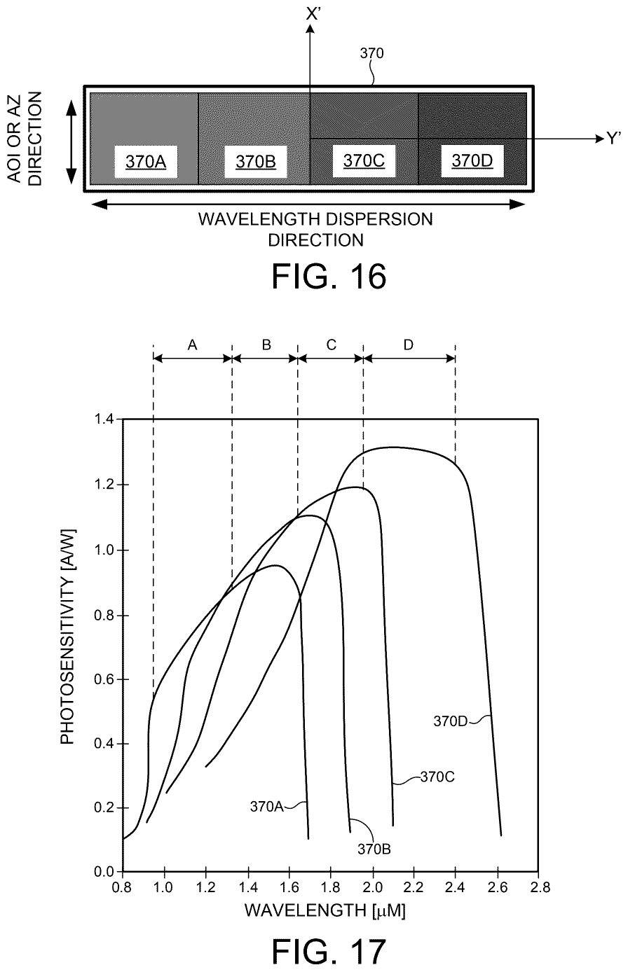

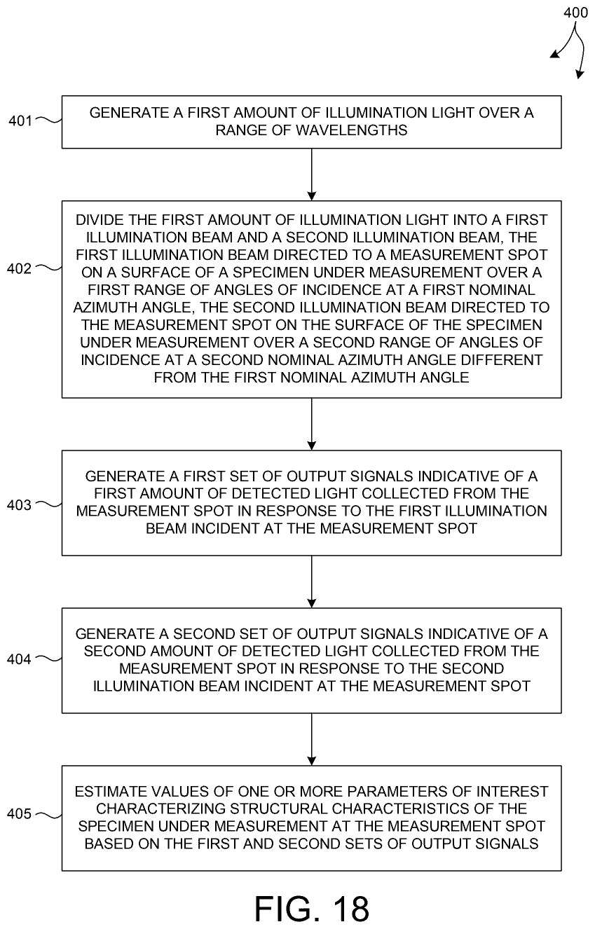

FIG. 16 depicts four sensor chips 370A-D derived from four different wavebands to make a multi-zone infrared detector 370. The four sensor chips include different material compositions that each exhibit different photosensitivity characteristics. As depicted in FIG. 16, sensor chip 370A exhibits high sensitivity over a waveband, A, sensor chip 370B exhibits high sensitivity over a waveband, B, sensor chip 370C exhibits high sensitivity over a waveband, C, and sensor chip 370D exhibits high sensitivity over a waveband, D. A metrology system incorporating detector 370 is configured to disperse wavelengths within waveband A onto sensor chip 370A, disperse wavelengths within waveband B onto sensor chip 370B, disperse wavelengths within waveband C onto sensor chip 370C, and disperse wavelengths within waveband D onto sensor chip 370D. In this manner, high photosensitivity (i.e., high SNR) is achieved over the aggregate waveband that includes wavebands A-D from a single detector. As a result measurement noise over the entire measurement range is reduced by limiting the use of a particular sensor to a narrowband where measurement sensitivity is high and measurement noise is low.

In some examples, a multi-zone detector includes InGaAs sensors with sensitivity to different spectral regions assembled in a single sensor package to produce a single, continuous spectrum covering wavelengths from 750 nanometers to 3,000 nanometers, or beyond.

In general, any number of individual sensors may be assembled along the direction of wavelength dispersion of the multi-zone detector such that a continuous spectrum maybe derived from the detector. However, typically, two to four individual sensors are employed in a multi-zone detector, such as detector 370.

In one embodiment, three individual sensors are employed with the first segment spanning the range between 800 nanometers and 1600 nanometers, the second segment spanning the range between 1600 nanometers and 2200nanometers, and the third segment spanning the range between 2200 nanometers and 2600 nanometers.

Although, the use of InGaAs based infrared detectors is specifically described herein, in general, any suitable material that exhibits narrow sensitivity ranges and sharp sensitivity cutoffs may be integrated into a multi-zone detector as described herein.

As depicted in FIG. 3, the illustrated measurement channel includes a polarizer on the illumination side and an analyzer on the collection side. However, in general, it is contemplated that any measurement channel may include, or not include, an illumination polarizer, a collection analyzer, an illumination compensator, a collection compensator, in any combination, to perform measurements of the polarized reflectivity of the sample, unpolarized reflectivity of the sample, or both.

In another further aspect, the dimensions of illumination pupil stop and the dimensions of the collection mask are adjusted to optimize the resulting measurement accuracy and speed based on the nature of target under measurement.

In another further aspect, the dimensions of illumination field stop are adjusted to achieve the desired spectral resolution for each measurement application.

In some examples, e.g., if the sample is a very thick film or grating structure, the illumination field stop projected on wafer plane in the direction perpendicular to the plane of incidence is adjusted to reduce the field size to achieve increase spectral resolution. In some examples, e.g., if the sample is a thin film, the illumination field stop projected on wafer plane in the direction perpendicular to the plane of incidence is adjusted to increase the field size to achieve a shortened measurement time without losing spectral resolution.

In the embodiments depicted in FIGS. 1 and 4, computing system 130 is configured to receive signals 171-174 indicative of the detected images. Computing system 130 is further configured to determine control signals 175 and 176 that are communicated to illumination sources 140 and 190, respectively. Illumination sources 140 and 190 receive the control signals and adjust illumination properties, e.g., output power, spectral content, etc., in accordance with control signal values.

FIG. 13 illustrates a method 400 of performing multi-angle measurements in at least one novel aspect. Method 400 is suitable for implementation by a metrology system such as metrology systems 100 and 200 illustrated in FIGS. 1 and 4, respectively, of the present invention. In one aspect, it is recognized that data processing blocks of method 400 may be carried out via a pre-programmed algorithm executed by one or more processors of computing system 130, or any other general purpose computing system. It is recognized herein that the particular structural aspects of metrology systems 100 and 200 do not represent limitations and should be interpreted as illustrative only.

In block 401, a first amount of illumination light is generated over a range of wavelengths by at least one illumination source.

In block 402, the first amount of illumination light is divided into a first illumination beam and a second illumination beam. The first illumination beam is directed to a measurement spot on a surface of a specimen under measurement over a first range of angles of incidence at a first nominal azimuth angle. The second illumination beam is directed to the measurement spot on the surface of the specimen under measurement over a second range of angles of incidence at a second nominal azimuth angle different from the first nominal azimuth angle.

In block 403, a first set of output signals is generated. The first set of output signals is indicative of a first amount of detected light collected from the measurement spot in response to the first illumination beam incident at the measurement spot.

In block 404, a second set of output signals is generated. The second set of outputs signals is indicative of a second amount of detected light collected from the measurement spot in response to the second illumination beam incident at the measurement spot.

In block 405, values of one or more parameters of interest characterizing structural characteristics of the specimen under measurement at the measurement spot are estimated based on the first and second sets of output signals.

In a further embodiment, system 100 includes one or more computing systems 130 employed to perform measurements of actual device structures based on multi-angle measurement data collected in accordance with the methods described herein. The one or more computing systems 130 may be communicatively coupled to each measurement channel. In one aspect, the one or more computing systems 130 are configured to receive measurement data associated with measurements of the structure of the specimen under measurement.

It should be recognized that one or more steps described throughout the present disclosure may be carried out by a single computer system 130 or, alternatively, a multiple computer system 130. Moreover, different subsystems of measurement systems 100 and 200 may include a computer system suitable for carrying out at least a portion of the steps described herein. Therefore, the aforementioned description should not be interpreted as a limitation on the present invention but merely an illustration.

In addition, the computer system 130 may be communicatively coupled to the measurement channels in any manner known in the art. For example, the one or more computing systems 130 may be coupled to computing systems associated with each measurement channel. In another example, the measurement channels may be controlled directly by a single computer system coupled to computer system 130.

The computer system 130 of metrology systems 100 and 200 may be configured to receive and/or acquire data or information from the subsystems of the system (e.g., spectrometers and the like) by a transmission medium that may include wireline and/or wireless portions. In this manner, the transmission medium may serve as a data link between the computer system 130 and other subsystems of system 100.

Computer system 130 of metrology systems 100 and 200 may be configured to receive and/or acquire data or information (e.g., measurement results, modeling inputs, modeling results, reference measurement results, etc.) from other systems by a transmission medium that may include wireline and/or wireless portions. In this manner, the transmission medium may serve as a data link between the computer system 130 and other systems (e.g., memory on-board metrology systems 100 and 200, external memory, or other external systems). For example, the computing system 130 may be configured to receive measurement data from a storage medium (i.e., memory 132 or an external memory) via a data link. For instance, measurement results obtained using the detectors described herein may be stored in a permanent or semi-permanent memory device (e.g., memory 132 or an external memory). In this regard, the measurement results may be imported from on-board memory or from an external memory system. Moreover, the computer system 130 may send data to other systems via a transmission medium. For instance, a measurement model or an estimated parameter value 180 determined by computer system 130 may be communicated and stored in an external memory. In this regard, measurement results may be exported to another system.

Computing system 130 may include, but is not limited to, a personal computer system, mainframe computer system, workstation, image computer, parallel processor, cloud based computing system, or any other device known in the art. In general, the term “computing system” may be broadly defined to encompass any device having one or more processors, which execute instructions from a memory medium.

Program instructions 134 implementing methods such as those described herein may be transmitted over a transmission medium such as a wire, cable, or wireless transmission link. For example, as illustrated in FIG. 1, program instructions 134 stored in memory 132 are transmitted to processor 131 over bus 133. Program instructions 134 are stored in a computer readable medium (e.g., memory 132). Exemplary computer-readable media include read-only memory, a random access memory, a magnetic or optical disk, or a magnetic tape.

In some examples, the measurement models are implemented as an element of a SpectraShape® optical critical-dimension metrology system available from KLA-Tencor Corporation, Milpitas, California, USA. In this manner, the model is created and ready for use immediately after the spectra are collected by the system.

In some other examples, the measurement models are implemented off-line, for example, by a computing system implementing AcuShape® software available from KLA-Tencor Corporation, Milpitas, California, USA. The resulting, trained model may be incorporated as an element of an AcuShape® library that is accessible by a metrology system performing measurements.

In another aspect, the methods and systems for multi-angle measurement of semiconductor devices described herein are applied to the measurement of high aspect ratio (HAR) structures, large lateral dimension structures, or both. The described embodiments enable optical critical dimension (CD), film, and composition metrology for semiconductor devices including three dimensional NAND structures, such as vertical-NAND (V-NAND) structures, dynamic random access memory structures (DRAM), etc., manufactured by various semiconductor manufacturers such as Samsung Inc. (South Korea), SK Hynix Inc. (South Korea), Toshiba Corporation (Japan), and Micron Technology, Inc. (United States), etc. These complex devices suffer from low light penetration into the structure(s) being measured. FIG. 12 depicts an exemplary high aspect ratio structure 270 that suffers from low light penetration into the structure(s) being measured. A multi-angle measurement system with broadband capability and wide ranges of collection angle and nominal azimuth angle having simultaneous spectral band and polarization state detection as described herein is suitable for measurements of these high-aspect ratio structures. HAR structures often include hard mask layers to facilitate etch processes for HARs. As described herein, the term “HAR structure” refers to any structure characterized by an aspect ratio that exceeds 2:1 or 10:1, and may be as high as 100:1, or higher.

In yet another aspect, the measurement results described herein can be used to provide active feedback to a process tool (e.g., lithography tool, etch tool, deposition tool, etc.). For example, values of measured parameters determined based on measurement methods described herein can be communicated to a lithography tool to adjust the lithography system to achieve a desired output. In a similar way etch parameters (e.g., etch time, diffusivity, etc.) or deposition parameters (e.g., time, concentration, etc.) may be included in a measurement model to provide active feedback to etch tools or deposition tools, respectively. In some example, corrections to process parameters determined based on measured device parameter values and a trained measurement model may be communicated to a lithography tool, etch tool, or deposition tool.

As described herein, the term “critical dimension” includes any critical dimension of a structure (e.g., bottom critical dimension, middle critical dimension, top critical dimension, sidewall angle, grating height, etc.), a critical dimension between any two or more structures (e.g., distance between two structures), and a displacement between two or more structures (e.g., overlay displacement between overlaying grating structures, etc.). Structures may include three dimensional structures, patterned structures, overlay structures, etc.

As described herein, the term “critical dimension application” or “critical dimension measurement application” includes any critical dimension measurement.

As described herein, the term “metrology system” includes any system employed at least in part to characterize a specimen in any aspect, including measurement applications such as critical dimension metrology, overlay metrology, tilt or center of line (CLS)shift metrology, critical dimension and pitch distortion metrology, focus/dosage metrology, film thickness metrology, and composition metrology. However, such terms of art do not limit the scope of the term “metrology system” as described herein. In addition, the metrology system 100 may be configured for measurement of patterned wafers and/or unpatterned wafers. The metrology system may be configured as a LED inspection tool, edge inspection tool, backside inspection tool, macro-inspection tool, or multi-mode inspection tool (involving data from one or more platforms simultaneously), and any other metrology or inspection tool that benefits from angle resolved collection NA.

Various embodiments are described herein for a semiconductor measurement system that may be used for measuring a specimen within any semiconductor processing tool (e.g., an inspection system or a lithography system). The term “specimen” is used herein to refer to a wafer, a reticle, or any other sample that may be processed (e.g., printed or inspected for defects) by means known in the art.

As used herein, the term “wafer” generally refers to substrates formed of a semiconductor or non-semiconductor material. Examples include, but are not limited to, monocrystalline silicon, gallium arsenide, and indium phosphide. Such substrates may be commonly found and/or processed in semiconductor fabrication facilities. In some cases, a wafer may include only the substrate (i.e., bare wafer). Alternatively, a wafer may include one or more layers of different materials formed upon a substrate. One or more layers formed on a wafer may be “patterned” or “unpatterned.” For example, a wafer may include a plurality of dies having repeatable pattern features.

A “reticle” may be a reticle at any stage of a reticle fabrication process, or a completed reticle that may or may not be released for use in a semiconductor fabrication facility. A reticle, or a “mask,” is generally defined as a substantially transparent substrate having substantially opaque regions formed thereon and configured in a pattern. The substrate may include, for example, a glass material such as amorphous SiO2. A reticle may be disposed above a resist-covered wafer during an exposure step of a lithography process such that the pattern on the reticle may be transferred to the resist.

One or more layers formed on a wafer may be patterned or unpatterned. For example, a wafer may include a plurality of dies, each having repeatable pattern features. Formation and processing of such layers of material may ultimately result in completed devices. Many different types of devices may be formed on a wafer, and the term wafer as used herein is intended to encompass a wafer on which any type of device known in the art is being fabricated.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

Although certain specific embodiments are described above for instructional purposes, the teachings of this patent document have general applicability and are not limited to the specific embodiments described above. Accordingly, various modifications, adaptations, and combinations of various features of the described embodiments can be practiced without departing from the scope of the invention as set forth in the claims.

What is claimed is:

1. A semiconductor measurement system comprising:
a first illumination source configured to generate a first amount of illumination light over a range of wavelengths;
one or more optical elements configured to divide the first amount of illumination light into a first illumination beam and a second illumination beam, the first illumination beam directed to a measurement spot on a surface of a specimen under measurement over a first range of angles of incidence at a first nominal azimuth angle, the second illumination beam directed to the measurement spot on the surface of the specimen under measurement over a second range of angles of incidence at a second nominal azimuth angle different from the first nominal azimuth angle;
a first measurement channel including a first detector configured to generate a first set of output signals indicative of a first amount of detected light collected from the measurement spot in response to the first illumination beam incident at the measurement spot;
a second measurement channel including a second detector configured to generate a second set of output signals indicative of a second amount of detected light collected from the measurement spot in response to the second illumination beam incident at the measurement spot; and
a computing system configured to estimate values of one or more parameters of interest characterizing structural characteristics of the specimen under measurement at the measurement spot based on the first and second sets of output signals.

2. The semiconductor measurement system of claim 1, further comprising:
a wavelength dispersion device disposed in an optical path of the first amount of detected light from the measurement spot to the first detector, the wavelength dispersion device dispersing the first amount of detected light across an active surface of the first detector in a first direction based on wavelength.

3. The semiconductor measurement system of claim 2, wherein the first amount of detected light is dispersed across the active surface of the first detector in a second direction based on angle of incidence, wherein the second direction is perpendicular to the first direction.

4. The semiconductor measurement system of claim 1, further comprising:
an illumination polarizing element disposed in an optical path of the first illumination beam between the illumination source and the measurement spot; and
a first collection polarizing element disposed in an optical path of the first amount of detected light from the measurement spot to the first detector, wherein the first first amount of detected light includes multiple polarization states.

5. The semiconductor measurement system of claim 4, wherein the multiple polarization states are detected by the first detector simultaneously.

6. The semiconductor measurement system of claim 4, wherein the multiple polarization states are detected by the first detector sequentially.

7. The semiconductor measurement system of claim 1, further comprising:
a second illumination source configured to generate a second amount of illumination light directed to the measurement spot on the surface of the specimen under measurement at a third nominal azimuth angle, wherein the third nominal azimuth angle is different from the first nominal azimuth angle and the second nominal azimuth angle;
a third measurement channel including a third detector configured to generate a third set of output signals indicative of a third amount of detected light collected from the measurement spot in response to the second amount of illumination light incident at the measurement spot, wherein the estimating of the values of the one or more parameters of interest characterizing structural characteristics of the specimen under measurement at the measurement spot is further based on the third set of output signals.

8. The semiconductor measurement system of claim 1, further comprising:
a pupil mask disposed in a pupil plane in an optical path of the first amount of illumination light between the first illumination source and the first optical beam splitter, wherein the pupil mask defines an illumination numerical aperture of the first illumination beam and an illumination numerical aperture of the second illumination beam.

9. The semiconductor measurement system of claim 8, wherein the illumination numerical aperture of the first illumination beam and the illumination numerical aperture of the second illumination beam do not overlap in the pupil plane.

10. The semiconductor measurement system of claim 9, wherein the illumination aperture of the first illumination beam in an angle of incidence direction and the illumination aperture of the second illumination beam in an angle of incidence direction are greater than 15 degrees.

11. The semiconductor measurement system of claim 9, wherein the illumination aperture of the first illumination beam in an angle of incidence direction and the illumination aperture of the second illumination beam in an angle of incidence direction are different magnitudes.

12. The semiconductor measurement system of claim 1, wherein the first measurement channel, the second measurement channel, or both, are configured as any of a spectroscopic ellipsometer, a spectroscopic reflectometer, and an interferometer.

13. The semiconductor measurement system of claim 1, wherein an illumination aperture of at least one of the first and second illumination beams in an angle of incidence direction is greater than 15 degrees.

14. A method comprising:
generating a first amount of illumination light over a range of wavelengths;
dividing the first amount of illumination light into a first illumination beam and a second illumination beam, the first illumination beam directed to a measurement spot on a surface of a specimen under measurement over a first range of angles of incidence at a first nominal azimuth angle, the second illumination beam directed to the measurement spot on the surface of the specimen under measurement over a second range of angles of incidence at a second nominal azimuth angle different from the first nominal azimuth angle;
generating a first set of output signals indicative of a first amount of detected light collected from the measurement spot in response to the first illumination beam incident at the measurement spot;
generating a second set of output signals indicative of a second amount of detected light collected from the measurement spot in response to the second illumination beam incident at the measurement spot; and
estimating values of one or more parameters of interest characterizing structural characteristics of the specimen under measurement at the measurement spot based on the first and second sets of output signals.

15. The method of claim 14, further comprising:
dispersing the first amount of detected light across an active surface of the first detector in a first direction based on wavelength and in a second direction based on angle of incidence.

16. The method of claim 14, further comprising:
simultaneously detecting multiple polarization states of the first amount of detected light.

17. The method of claim 14, further comprising:
defining an illumination numerical aperture of the first illumination beam and an illumination numerical aperture of the second illumination beam, wherein the illumination numerical aperture of the first illumination beam and the illumination numerical aperture of the second illumination beam do not overlap in an illumination pupil plane.

18. The method of claim 17, wherein the illumination numerical aperture of at least one of the first and second illumination beams in an angle of incidence direction is greater than 15 degrees.

19. A semiconductor measurement system comprising:
a first illumination source configured to generate a first amount of illumination light over a range of wavelengths;
one or more optical elements configured to divide the first amount of illumination light into a first illumination beam and a second illumination beam, the first illumination beam directed to a measurement spot on a surface of a specimen under measurement over a first range of angles of incidence at a first nominal azimuth angle, the second illumination beam directed to the measurement spot on the surface of the specimen under measurement over a second range of angles of incidence at a second nominal azimuth angle different from the first nominal azimuth angle;
a first measurement channel including a first detector configured to generate a first set of output signals indicative of a first amount of detected light collected from the measurement spot in response to the first illumination beam incident at the measurement spot;
a second measurement channel including a second detector configured to generate a second set of output signals indicative of a second amount of detected light collected from the measurement spot in response to the second illumination beam incident at the measurement spot; and
a non-transitory, computer-readable medium storing instructions that, when executed by one or more processors, causes the one or more processors to:
estimate values of one or more parameters of interest characterizing structural characteristics of the specimen under measurement at the measurement spot based on the first and second sets of output signals.

20. The semiconductor measurement system of claim 19, wherein the first measurement channel, the second measurement channel, or both, are configured as any of a spectroscopic ellipsometer, a spectroscopic reflectometer, and an interferometer.
